(19) United States
(12) Patent Application Publication
(10) Pub. No.: US 2012/0016971 A1
(43) Pub. Date: Jan. 19, 2012

(54) SERVER SYSTEM AND CONSTRUCTION METHOD FOR I/O CONFIGURATION OF SERVER SYSTEM

(75) Inventors: YOSHINORI WAKAI, Hadano (JP); Yutaka Tawara, Hadano (JP); Daisuke Kaguchi, Hadano (JP); Ken Imamura, Funabashi (JP); Eitaro Ito, Kokubunji (JP); Daisuke Nogami, Musashino (JP); Junko Suzuki, Tama (JP)

(73) Assignee: Hitachi, Ltd.

(21) Appl. No.: 13/179,209

(22) Filed: Jul. 8, 2011

(30) Foreign Application Priority Data
Jul. 13, 2010 (JP) 2010-158822

(51) Int. Cl. G06F 15/177

(52) U.S. Cl. 709/220

(57) ABSTRACT

At least one second I/O switch which a plurality of I/O devices is coupled to is coupled to at least one first I/O switch to which a plurality of servers is coupled. A configuration in which all servers that are coupled to the first I/O switch can be coupled to all I/O cards that are coupled to the at least one second I/O switch that is coupled to the first I/O switch is executed. The controller receives the specifications of a server unit and an I/O device unit that is to be coupled to the server unit. The controller executes a setting in which at least one I/O device that configures the specified I/O device unit is allocated to at least one server that configures the specified server unit to the second I/O switch to which the at least one I/O device is coupled.

### CROSS-REFERENCE TO PRIOR APPLICATION

This application relates to and claims the benefit of priority from Japanese Patent Application No. 2010-158822 filed on Jul. 13, 2010, the entire disclosure of which is incorporated herein by reference.

### BACKGROUND The present invention relates to a server system and a construction method for the server system.

A server system that is provided with a plurality of servers (hosts), a plurality of I/O (Input/Output) devices, and an I/O switch that is coupled to the servers (hosts) and the devices is known (see Patent Literature 1 for instance). [Patent Literature 1] Japanese Patent Application Laid-Open Publication No. 2007-280237

### SUMMARY

An I/O switch that is configured for a communication with a standard equivalent to that of a communication inside a server is known as an I/O switch. More specifically, in the case in which a standard of a communication inside a server is PCIe (PCI-Express), a PCIe switch can be adopted as an I/O switch.

A server system that is provided with a plurality of PCIe switches can be constructed. More specifically, a PCIe switch to which a plurality of I/O devices can be coupled (hereafter referred to as a post-stage PCIe switch) can be coupled to a PCIe switch to which a plurality of servers can be coupled (hereafter referred to as a pre-stage PCIe switch) for instance. A plurality of post-stage PCIe switches can also be coupled to one pre-stage PCIe switch. Moreover, a plurality of pre-stage PCIe switches can also be coupled to one post-stage PCIe switch.

In accordance with the above server system, a manager can couple any pre-stage PCIe switch and any post-stage PCIe switch to each other and can construct any I/O configuration (such as a configuration of a combination of a server and an I/O device and a configuration of a path that couple a server and an I/O device to each other) depending on a configuration to a PCIe switch.

However, a knowledge that is associated with an internal structure of a PCIe switch is required to understand an I/O configuration that is desired by a manager and a configuration of a PCIe switch for implement the I/O configuration. Consequently, a construction of an I/O configuration is a work with a high degree of difficulty.

This problem can exist even in the case in which an I/O switch other than a PCIe switch is used.

An object of the present invention is to easily construct an I/O configuration of a server system.

At least one second I/O switch which a plurality of I/O devices is coupled to at least one first I/O switch to which a plurality of servers is coupled. In that case, a configuration that is provided with a symmetric property is constructed. More specifically, a controller can implement a configuration in which all servers that are coupled to the first I/O switch can be coupled to all I/O cards that are coupled to the at least one second I/O switch that is coupled to the first I/O switch.

By constructing a configuration that is provided with a symmetric property, a management system that is coupled to the controller can receive a specification of a server unit (a unit that is configured by at least one server) and an I/O device unit (a unit that is configured by at least one I/O device) that is to be coupled to the server unit. The controller receives the information that indicates a server unit that is specified by the management system and an I/O device unit that is specified by the management system. The controller executes a setting in which at least one I/O device that configures the specified I/O device unit is allocated to at least one server that configures the specified server unit to the second I/O switch to which the at least one I/O device is coupled.

By the above configuration, an I/O configuration of a server system can be easily constructed.

### BRIEF DESCRIPTION OF THE DRAWINGS

FIG. 1 is a view showing a summary of the entire system in accordance with an embodiment of the present invention.

FIG. 2 is a view showing an example of a configuration of a server system in accordance with an embodiment of the present invention.

FIG. 3 is a view showing a configuration of a pre-stage controller 203 and a post-stage controller 213 shown in FIG. 2.

FIG. 4 is a view showing an example of a detailed configuration of a pre-stage PCIe switch and a post-stage PCIe switch.

FIG. 5A is a view showing some processing that is executed by a post-stage controller 203.

FIG. 5B is a view showing the server blade management information 500.

FIG. 6A is a view showing a detail of S3 of FIG. 5A.

FIG. 6B is a view showing the correspondence management information 600.

FIG. 7A is a view showing the blade/VS correspondence information 700.

FIG. 7B is a view showing the upstream setting information 710.

FIG. 8 is a view showing a setting at a completion of a construction of a basic configuration that is provided with a symmetric property.

FIG. 9 is a view showing a summary GUI 900.

FIG. 10A is a view showing the I/O card management information 1000.

FIG. 10B is a view showing an information collection that is executed by the post-stage controller 213.

FIG. 11 is a view showing a setting GUI 1100.

FIG. 12 is a view showing the downstream setting information 1200.

FIG. 13 is a view showing a detailed GUI 1300.

FIG. 14 is a view showing an example of an indication of the setting GUI 1100 in the case of being unallocated.

FIG. 15 is a view showing a GUI operation for an allocation of a partition.

FIG. 16 is a view showing a GUI operation for an allocation of an I/O card to a partition.

FIG. 17 is a view showing a GUI operation for an allocation of an I/O card to a partition.

FIG. 18 is a view showing a GUI operation for canceling an allocation of an I/O card from a partition.

FIG. 19 is a view showing a reflection (a transmission) of the information from a post-stage controller 213 to another post-stage controller 213.

FIG. 20 is a view showing a setting at a completion of a construction of a server system.

FIG. 21 is a view showing an example of a connection of an SMP (Symmetric Multi Processor).

FIG. 22A is a view showing an example of a configuration before the number of server blades that configure an SMP group is decreased.

FIG. 22B is a view showing an example of a configuration after the number of server blades that configure an SMP group is decreased.

FIG. 23A is a view showing that all server blades other than server blades that configure an SMP group are being operated for a partition #0.

FIG. 23B is a view showing that a post-stage VS #8 is allocated to the partition #0 shown in FIG. 23A.

FIG. 23C is a view showing that every server blade is not being operated for a partition #1.

FIG. 23D is a view showing that a post-stage VS #5 and a post-stage VS #9 are allocated to the partition #1 shown in FIG. 23C.

FIG. 24 is a view showing a flow of a partition configuration modification processing.

### DETAILED DESCRIPTION OF THE EMBODIMENT

An embodiment (example) of the present invention will be described below in detail with reference to the drawings.

In the following embodiment, a server is a server blade that is a server in a blade shape. An I/O device is an I/O card that is an I/O interface device in a card shape (for instance, an HBA (Host Bus Adapter) or a NIC (Network Interface Card)). A standard of a communication inside a server is a PCIe, and an I/O switch is a PCIe switch.

In the following descriptions, the processing will be described while a “program” is handled as a subject in some cases. In the case in which the program is executed by a processor (for instance, a CPU (Central Processing Unit)), the processor executes the predetermined processing by using a storage resource (such as a memory) and/or a communication interface apparatus (such as a communication port) as it decides proper. Consequently, a subject of a processing can also be a processor. The processing that is described while a program is handled as a subject can also be a processing that is executed by a processor or a controller that is provided with the processor. Moreover, the controller can be a CPU itself or can include a hardware circuit that executes a part or a whole of a processing that is executed by a processor. A program can be installed from a program source to each of the controllers. The program source can be a program distribution server or a storage medium for instance.

A management computer can also be at least one computer. For instance more specifically, in the case in which a management computer indicates the information or a management computer transmits the information for an indication to a remote computer, a management computer is a management system. Moreover, in the case in which a function equivalent to a management computer is implemented by using a plurality of computers for instance, the plurality of computers is a management system (the plurality of computers can include a computer for an indication in the case in which a computer for an indication executes an indication). In the following embodiment, a management computer is a management system.

In the following descriptions, while a number is adopted as a type of the identification information of a variety of targets (such as a slot, a server blade, an I/O card, a port, and a virtual switch), the identification information of other types (such as an alphabetic character, a numeric character, another symbol, and a combination thereof) can also be adopted.

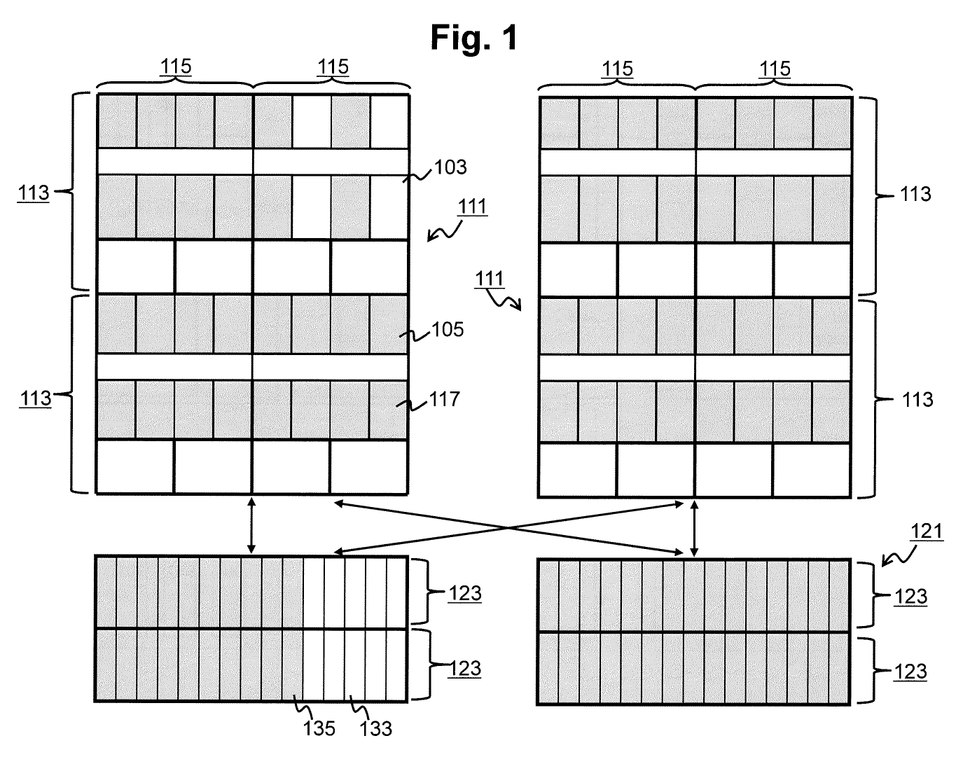

FIG. 1 is a view showing a summary of the entire system in accordance with an embodiment of the present invention.

There are at least one server rack 111 and at least one I/O expansion rack 121.

One server rack 111 is provided with at least one server chassis 113. One server chassis 113 is provided with at least one partition 115. One partition 115 is provided with K slots 103 (K is an integer number equal to or larger than 2, K=4 for instance). A server blade 105 is inserted into the slot 103.

A front plane 117 is disposed in one partition 115. The front plane 117 is a circuit board that is coupled to the front side of each of the server blades 105 that have been mounted on the partition 115. The front plane 117 is a circuit board that is configured to implement an SMP (Symmetric Multi Processor) connection. The SMP connection will be described in detail later.

The I/O expansion rack 121 is provided with at least one I/O expansion chassis 123. The I/O expansion chassis 123 is provided with J slots 133 (J is an integer number equal to or larger than 1, J=16 for instance). An I/O card 135 is inserted into the slot 133.

A plurality of servers can also be disposed. A user and a server system can be allocated in which the user of a plurality of users (hereafter referred to as a tenant) can use the at least one server system of a plurality of server systems. The server system is provided with at least two partitions 115 and at least one I/O card 135. The server system does not always include a mechanism that is configured to implement an SMP connection. In that case, one server blade can be handled as one partition.

One server system will be described as an example in the following.

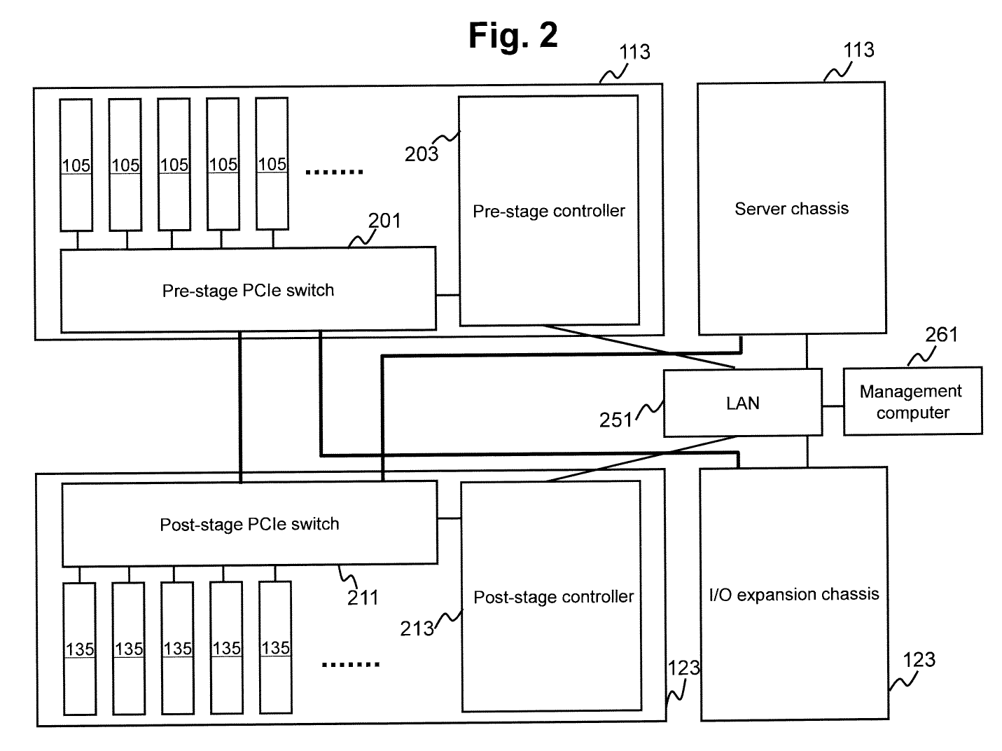

FIG. 2 is a view showing an example of a configuration of a server system in accordance with an embodiment of the present invention.

The server chassis 113 is provided with a PCIe switch 201 and a controller 203. The I/O expansion chassis 123 is also provided with a PCIe switch 211 and a controller 213. The PCIe switch and the controller in the server chassis 113 will be hereafter referred to as a pre-stage PCIe switch and a pre-stage controller, and the PCIe switch and the controller in the I/O expansion chassis 123 will be hereafter referred to as a post-stage PCIe switch and a post-stage controller.

The pre-stage controller 203 in each of the server chassis 113 and the pre-stage controller 213 in each of the I/O expansion chassis 123 are coupled to a LAN (Local Area Network) 251. A management computer 261 is coupled to the LAN 251. The management computer 261 is a computer that is used by a manager. Although it is not shown, the management computer 261 is provided with a communication interface apparatus, a storage resource (such as a memory), an input device (such as a keyboard and/or a pointing device), a display apparatus, and a processor that is coupled to them for instance. An apparatus in which an input device and a display apparatus are configured in an integrated manner (such as a display apparatus of a touch panel type) can also be adopted. A communication network of other type can also be adopted as substitute for or in addition to a LAN. The LAN 251 is configured by at least one LAN switch for instance.

The pre-stage controller 203 is coupled to the pre-stage PCIe switch 201. The server blade 105 that has been inserted into the slot 103 is coupled to the pre-stage PCIe switch 201. The pre-stage controller 203 manages the configuration information that includes the configuration that indicates a slot 103 into which the server blade 105 that has been coupled to the pre-stage PCIe switch 201 has been inserted.

The post-stage controller 213 is coupled to the post-stage PCIe switch 211. The I/O card 135 that has been inserted into the slot 133 is coupled to the post-stage PCIe switch 211. The post-stage controller 213 manages the configuration information that includes the configuration that indicates a slot 133 into which the I/O card 135 that has been coupled to the post-stage PCIe switch 211 has been inserted.

All of the post-stage PCIe switches 211 in the server system are coupled to each pre-stage PCIe switch 201 in the server system. Moreover, all of the pre-stage PCIe switches 201 in the server system are coupled to each post-stage PCIe switch 211 in the server system. A plurality of pre-stage PCIe switches 201 can be mounted on one server chassis. A plurality of separate post-stage PCIe switches 211 can be coupled to a plurality of pre-stage PCIe switches 201.

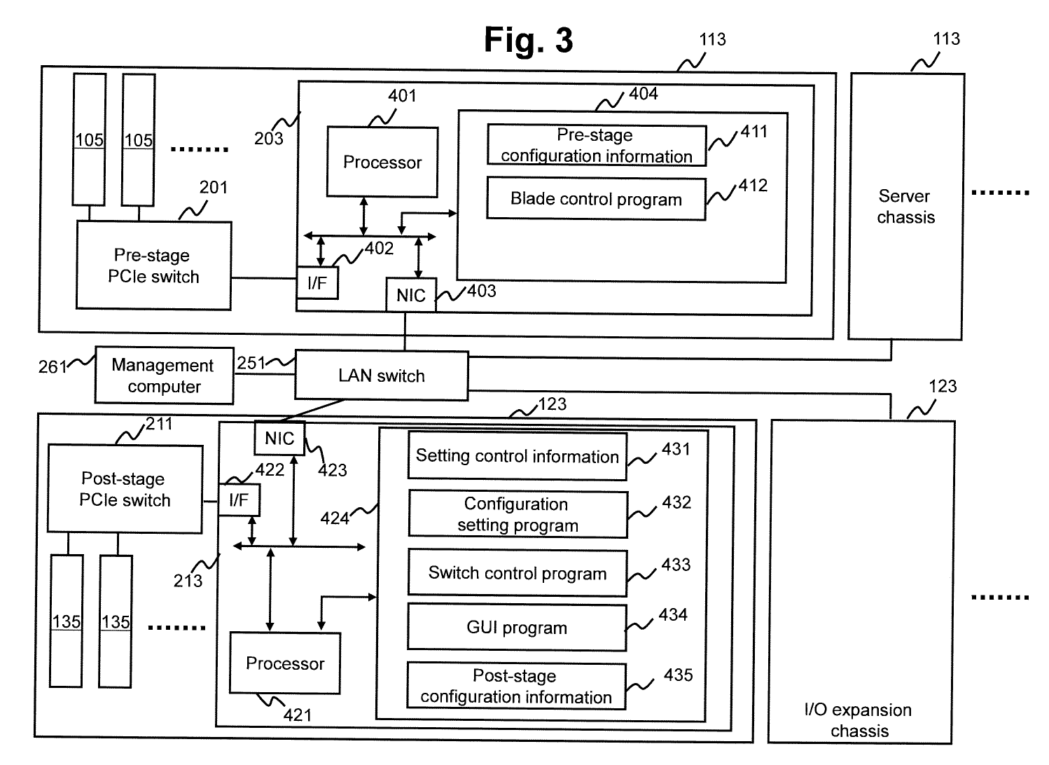

FIG. 3 is a view showing a configuration of a pre-stage controller 203 and a post-stage controller 213 shown in FIG. 2.

The pre-stage controller 203 is provided with a switch interface (I/F) 402, a MC 403, a storage resource (such as a memory) 404, and a processor 401 that is coupled to them. The pre-stage PCIe switch 201 is coupled to the I/F 402, and the LAN 251 is coupled to the NIC 403.

The storage resource 404 stores the information and a computer program. As the information, the pre-stage configuration information 411 is stored for instance. As a computer program, a blade control program 412 is stored for instance. The processor executes the blade control program 412. The pre-stage configuration information 411 is information that is related to a configuration of the chassis 113 that is provided with the information 411. The information 411 and the program 412 will be described in detail later.

The post-stage controller 213 is provided with a switch interface (I/F) 422, a NIC 423, a storage resource (such as a memory) 424, and a processor 421 that is coupled to them. The post-stage PCIe switch 211 is coupled to the I/F 422, and the LAN 251 is coupled to the NIC 423.

The storage resource 424 stores the information and a computer program. As the information, the setting control information 431 and the post-stage configuration information 435 are stored for instance. As a computer program, a configuration setting program 432, a switch control program 433, and a GUI program 434 are stored for instance. The processor executes the configuration setting program 432 and the switch control program 433. The setting control information 431 is information that is related to a setting of the post-stage PCIe. The post-stage configuration information 435 is information that is related to a configuration of the chassis 123 that is provided with the information 435. The information 431, the information 435, and the programs 432 to 434 will be described in detail later.

At least one post-stage controller 213 is provided with the GUI program 434 in one server system. The GUI program 434 is downloaded to the management computer 261 of the server system and is stored into a storage resource in the management computer 261. The GUI program 434 that has been stored into the storage resource is executed by a processor in the management computer 261. The GUI program 434 can also be downloaded to the management computer 261 from another program source (such as the pre-stage controller 203) as substitute for the post-stage controller 213.

At least one post-stage controller 213 is provided with the configuration setting program 432 in one server system. The configuration setting program 432 communicates with the management computer 261 of a download destination of the GUI program 434. Moreover, the configuration setting program 432 can collect the information that is indicated by the configuration information 435 from all of the post-stage controllers 213 in the server system.

In the present embodiment, the following (X1) to (X3) will be executed:
(X1) a construction of a basic configuration that is provided with a symmetric property;
(X2) a display of a GUI (Graphical User Interface) and a GUI operation by a manger; and
(X3) the information setting that conforms to the GUI operation by a manger. In the case in which (X3) is completed, a server blade 105 can execute an I/O via the I/O card 135 that has been allocated to the server blade 105.

Each of the processing will be described in the following.

<(X1) Construction of a Basic Configuration that is Provided with a Symmetric Property>

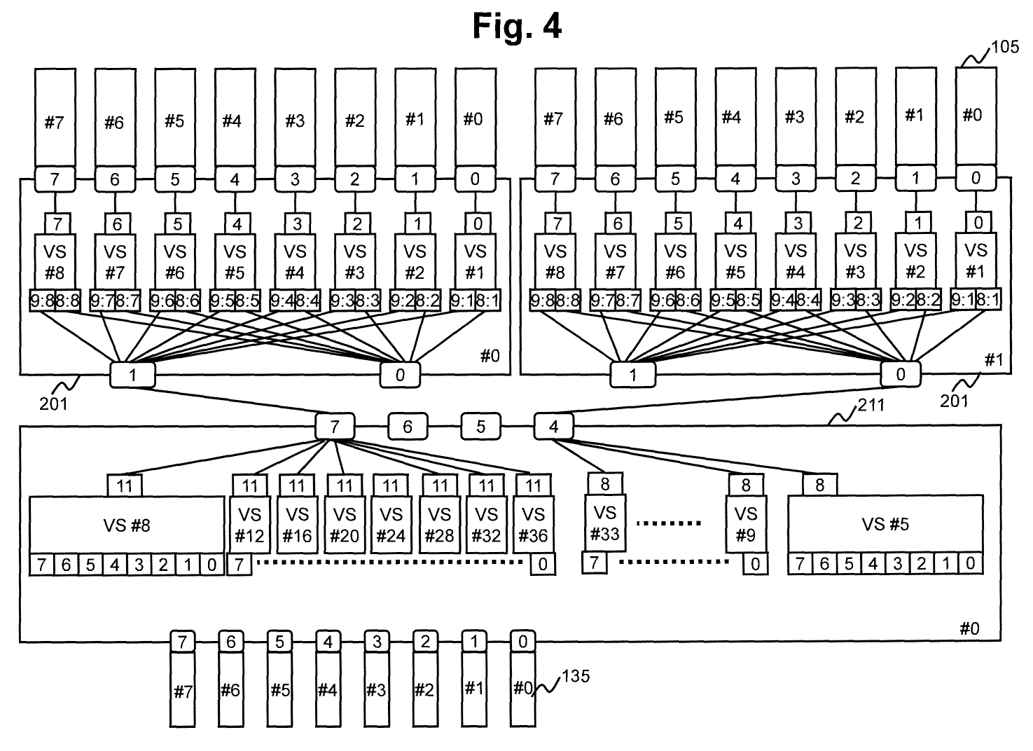

FIG. 4 is a view showing an example of a detailed configuration of a pre-stage PCIe switch and a post-stage PCIe switch.

The pre-stage PCIe switch and the post-stage PCIe switch is provided with a plurality of upstream ports, a plurality of downstream ports, and a plurality of virtual switches (hereafter referred to as a VS).

The upstream port is a communication port that is coupled to a device on the upstream side.

The downstream port is a communication port that is coupled to a device on the downstream side.

The VS is a virtual I/O switch, and is provided with a virtual upstream port and at least one virtual downstream port. The VS can add a VHN (Virtual Hierarchy Number) to the input information and output the information with the VHN, or can remove the VHN that has been added to the input information and output the information without the VHN.

A server chassis of a chassis number “n” is referred to as a server chassis #n and a pre-stage PCIe switch in the server chassis #n is referred to as a pre-stage PCIe switch #n in some cases in the following. Similarly, an I/O expansion chassis of a chassis number “m” is referred to as an I/O expansion chassis #m and a post-stage PCIe switch in the I/O expansion chassis #m is referred to as a post-stage PCIe switch #m in some cases in the following. Moreover, a port of a port “p” is referred to as a port #p in some cases in the following. Moreover, a VS of a virtual switch number “q” is referred to as a VS #q in some cases in the following. Moreover, a VS in a pre-stage PCIe switch is referred to as a pre-stage VS, and a VS in a post-stage PCIe switch is referred to as a post-stage VS in some cases in the following. In FIG. 4, a description of “s:t” in a virtual downstream port that is included in the pre-stage VS and a description of “s:t” in a virtual upstream port that is included in the post-stage VS represent that a VHN “t” is added to the information that is output from a port of a port number “s”. Moreover, an upstream port and a downstream port of a pre-stage PCIe switch are referred to as a pre-stage upstream port and a pre-stage downstream port, respectively, and an upstream port and a downstream port of a post-stage PCIe switch are referred to as a post-stage upstream port and a post-stage downstream port, respectively, in some cases in the following. In an example shown in FIG. 4, the pre-stage PCIe switch is provided with eight pre-stage upstream ports and two pre-stage downstream ports. However, the numbers of the pre-stage upstream ports and the pre-stage downstream ports that are included in one pre-stage PCIe switch are not restricted to the above numbers. Similarly, although the post-stage PCIe switch is provided with four post-stage upstream ports and eight post-stage downstream ports, the numbers of the post-stage upstream ports and the post-stage downstream ports that are included in one post-stage PCIe switch are not restricted to the above numbers. (Although the number of the post-stage downstream ports is larger than eight in FIG. 1, the number of the post-stage downstream ports is eight in FIG. 4 for a convenience of the description.)

An example that is shown in FIG. 4 represents the following status. The maximum number of server blades that can be mounted on one server chassis is N in the following.
(*) An upstream port #7 of a post-stage PCIe switch #0 is coupled to a downstream port #1 of a pre-stage PCIe switch #0, and an upstream port #4 of a post-stage PCIe switch #0 is coupled to a downstream port #0 of a pre-stage PCIe switch #1.
(*) Each of the pre-stage VS is provided with one virtual upstream port for all of the pre-stage PCIe switches, and one server blade is coupled to the virtual upstream port.
(*) All of the downstream ports of the pre-stage PCIe switch are coupled to each of the pre-stage VS for all of the pre-stage PCIe switches. In other words, all of the pre-stage VS are coupled to all of the downstream ports of the pre-stage PCIe switch.
(*) At least N post-stage VS (N=8) is coupled to each of the post-stage upstream ports. The number of the virtual upstream ports that are included in one post-stage VS is 1. Consequently, one post-stage VS is coupled to one post-stage upstream port. In other words, a post-stage VS is not coupled to a plurality of post-stage upstream ports. In accordance with a prescribed rule, N post-stage VS are coupled to the post-stage upstream port in advance. In accordance with a prescribed rule, the number of eight post-stage VS that are allocated to the post-stage upstream port #4 is 4a+5, the number of eight post-stage VS that are allocated to the post-stage upstream port #5 is 4a+6, the number of eight post-stage VS that are allocated to the post-stage upstream port #6 is 4a+7, and the number of eight post-stage VS that are allocated to the post-stage upstream port #7 is 4a+8 for instance. “a” is a number of a server blade (a number of a slot in which a server blade is inserted) and an integer number in the range of 0 to 7 for instance. Consequently, eight post-stage VS #8, #12, #16, #20, #24, #28, #32, and #36 are coupled to the post-stage upstream port #7 for instance. For instance, a post-stage upstream port and eight post-stage VS that are coupled to the post-stage upstream port may be decided by a post-stage controller 213 or a manager in a random manner, and the information that indicates a correspondence relationship between a post-stage VS # and a post-stage upstream port may be stored into the storage resource 424 and the post-stage PCIe switch 211
(*) Any server blade is not corresponded to any post-stage VS in the post-stage PCIe switch #0.
(*) Any I/O card in the I/O expansion chassis #0 is not corresponded to any post-stage VS in the post-stage PCIe switch #0.

In such a status, a construction of a basic configuration that is provided with a symmetric property is executed.

The “basic configuration” means a configuration of a path from a server blade to a post-stage VS.

The “basic configuration that is provided with a symmetric property” is a basic configuration in which all of the server blades in the same server system can access all of the I/O cards that are coupled to the specific post-stage PCIe switch. The “specific post-stage PCIe switch” is a post-stage PCIe switch that is coupled to the pre-stage PCIe switch to which the all of the servers are coupled.

The construction of the basic configuration that is provided with a symmetric property is implemented as described in the following for instance.

The pre-stage configuration information 411 (see FIG. 3) is provided with the following information for each of the pre-stage controller 203 for instance:
(*) the information that indicates a partition 113 and a slot 103 in which a server blade 105 has been inserted; and
(*) the information that indicates an SMP group and server blades 105 that configure the SMP group.
   The SMP group is a group of at least one server blade 105 in which an SMP connection has been executed, that is, a group of at least one server blade 105 that configures a scale-up server. A number of the server blade 105 can be equivalent to that of the slot 103, or can be a number that is calculated based on a number of the slot 103.

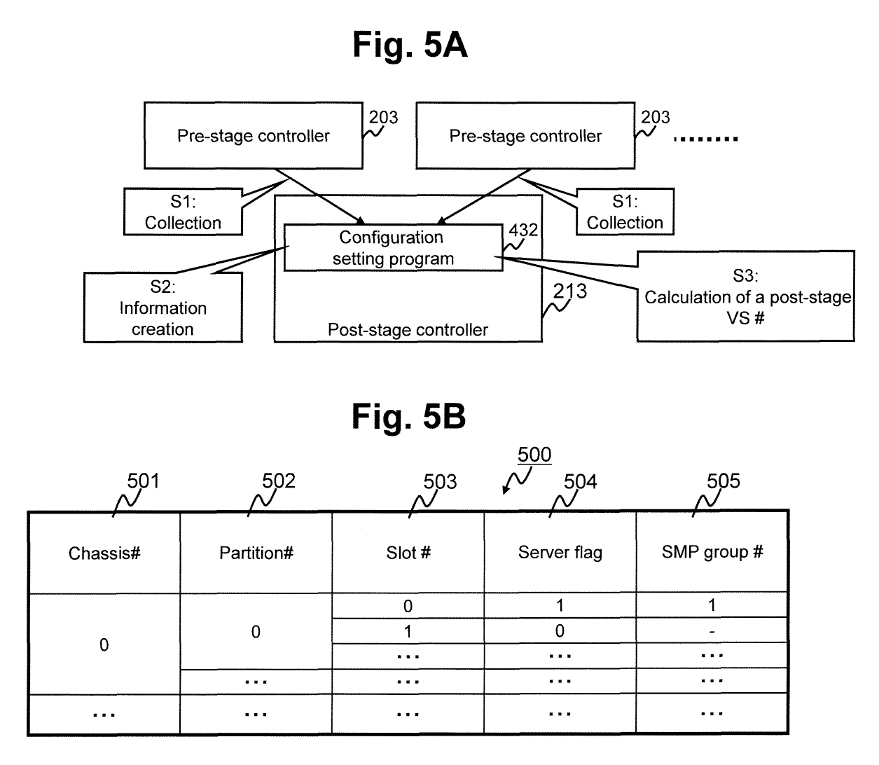

As shown in FIG. 5A, the configuration setting program 432 of the pre-stage controller 203 executes the following processing:
(S1) collects the information (such as a number of a partition, a number of a slot, and an existence or non-existence of a server blade) that is included in the pre-stage configuration information 411 from all of the pre-stage controllers 203 by communicating with the blade control program 412 of all of the pre-stage controllers 203 via the LAN 251;
(S2) creates the server blade management information 500 shown in FIG. 5B in a storage resource 424 based on the collected information; and
(S3) decides a server blade and a post-stage VS that is allocated to the server blade based on the collected information (calculates the post-stage VS #).

As shown in FIG. 5B, the server blade management information 500 is provided with the following information for each slot 103 for instance:
(*) a chassis #501 that is a number of the server chassis 113 that is provided with the slot 103;
(*) a partition #502 that is a number of the partition 115 that is provided with the slot 103;
(*) the slot #503 that is a number of the slot 103;
(*) a server flag 504 that indicates whether or not a server blade 105 has been inserted into the slot 103; and
(*) an SMP group #505 that is a number of the SMP group to which the server blade 105 that has been inserted into the slot 103 belongs.
   The information 502 to 505 are the information that has been obtained from the information that has been collected, and the information 501 is the information that has been specified and added based on the pre-stage controller 203 that is a collecting source of the information. More specifically, the storage resource 424 in the post-stage controller 213 that is provided with the configuration setting program 432 can store the information that indicates an IP address of the pre-stage controller 203 and the server chassis 113 in which the pre-stage controller 203 exists for instance. Based on the information, the configuration setting program 432 can specify a chassis # that is corresponded to an IP address of the pre-stage controller 203 that is a collecting source of the information and can include the specified chassis #501 into the server blade management information 500.

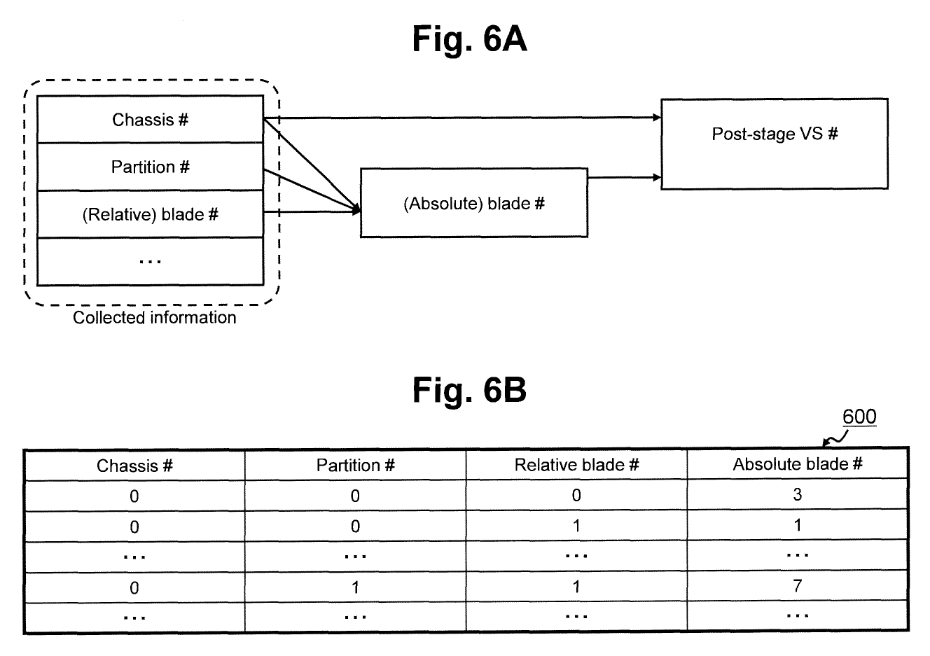

In the above (S3), the configuration setting program 432 executes the processing shown in FIG. 6A for instance:
(S3-1) calculates an absolute blade # (a unique server blade number in one server chassis 113) by using a chassis #, a partition #, and a blade # (a relative blade #) in the information that has been collected from the pre-stage controller 203; and
(S3-2) calculates a VS # of the post-stage VS in accordance with a prescribed rule by using a chassis # and an absolute blade #.

The absolute blade # can be calculated based on a first calculating formula in which a chassis #, a partition #, and a blade # in the information that has been collected are variables, or can be calculated by using the correspondence management information 600 shown in FIG. 6B. The correspondence management information 600 is the information that indicates a correspondence relationship between a chassis #, a partition #, and a blade # (a relative blade #) in the information that has been collected and an absolute blade # for the server chassis 113 of the chassis #. The correspondence management information 600 is the information that has been stored into the storage resource 424 for instance.

The VS # of the post-stage VS can be calculated based on a second calculating formula in which an absolute blade # is a variable, or can be decided based on the information that indicates a correspondence relationship between a chassis # and an absolute blade # and the VS # of the post-stage VS. For instance, one second calculating formula can be selected from a second calculating formula group that is composed of a plurality of second calculating formulas by using the chassis #. The second calculating formula group is configured by the following formulas for instance:

VS#=4b+5

VS#=4b+6

VS#=4b+7

VS#=4b+8

A value that is added to 4b is any one of 5, 6, 7, and 8. The value is different depending on the second calculating formula group. The second calculating formula group can exist for every post-stage PCIe switch (for every I/O expansion chassis).

Here, “b” is a number of a server blade (a number of a slot into which a server blade has been inserted) and is an integer number in the range of 0 to 7 for instance.

In accordance with an example of FIG. 4, only the post-stage upstream port #7 of the four post-stage upstream ports #4 to #7 is coupled to the pre-stage PCIe switch #0, and only eight post-stage VS #8, #12, #16, #20, #24, #28, #32, and #36 of a plurality of post-stage VS are coupled to the post-stage upstream port #7. As a second calculating formula that is corresponded to a chassis # (a number 0 of a server chassis), “VS #=4b+8” is selected. Consequently, the configuration setting program 432 executes the following decisions:
(*) allocates a server blade #0 in a server chassis #0 to a VS #8 (VS #8=4×0+8(b=0));
(*) allocates a server blade #1 in a server chassis #0 to a VS #12 (VS #12=4×1+8(b=1));
(*) allocates a server blade #2 in a server chassis #0 to a VS #16 (VS #16=4×2+8(b=2));
(*) allocates a server blade #3 in a server chassis #0 to a VS #20 (VS #20=4×3+8(b=3));
(*) allocates a server blade #4 in a server chassis #0 to a VS #24 (VS #24=4×4+8(b=4));
(*) allocates a server blade #5 in a server chassis #0 to a VS #28 (VS #28=4×5+8(b=5));
(*) allocates a server blade #6 in a server chassis #0 to a VS #32 (VS #32=4×6+8(b=6)); and
(*) allocates a server blade #7 in a server chassis #0 to a VS #36 (VS #36=4×7+8(b=7)).

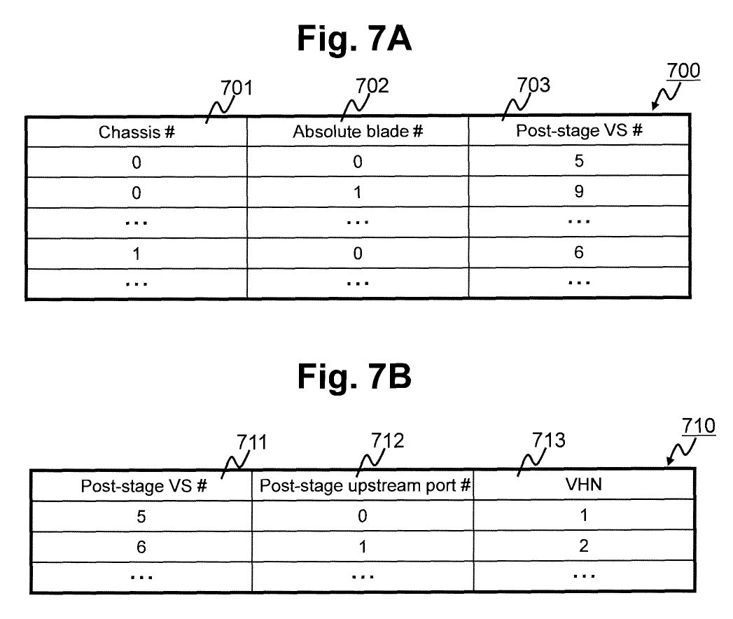

The configuration setting program 432 executes the following decisions creates the blade/VS correspondence information 700 shown in FIG. 7A in the storage resource 424 based on the calculation results. The blade/VS correspondence information 700 is the information that is included in the setting control information 431 for instance. The blade/VS correspondence information 700 shown in FIG. 7A is provided with the following information for every post-stage VS of the post-stage PCIe switch 211 in the I/O expansion chassis 123 that is provided with the blade/VS correspondence information 700:
(*) a chassis #701 that represents a number of a server chassis that is corresponded to the post-stage VS;
(*) an absolute blade #702 that represents a number of a server blade that is corresponded to the post-stage VS (a number by which a server blade is uniquely identified in a server chassis); and
(*) a post-stage VS #703 that is a number of the post-stage VS.

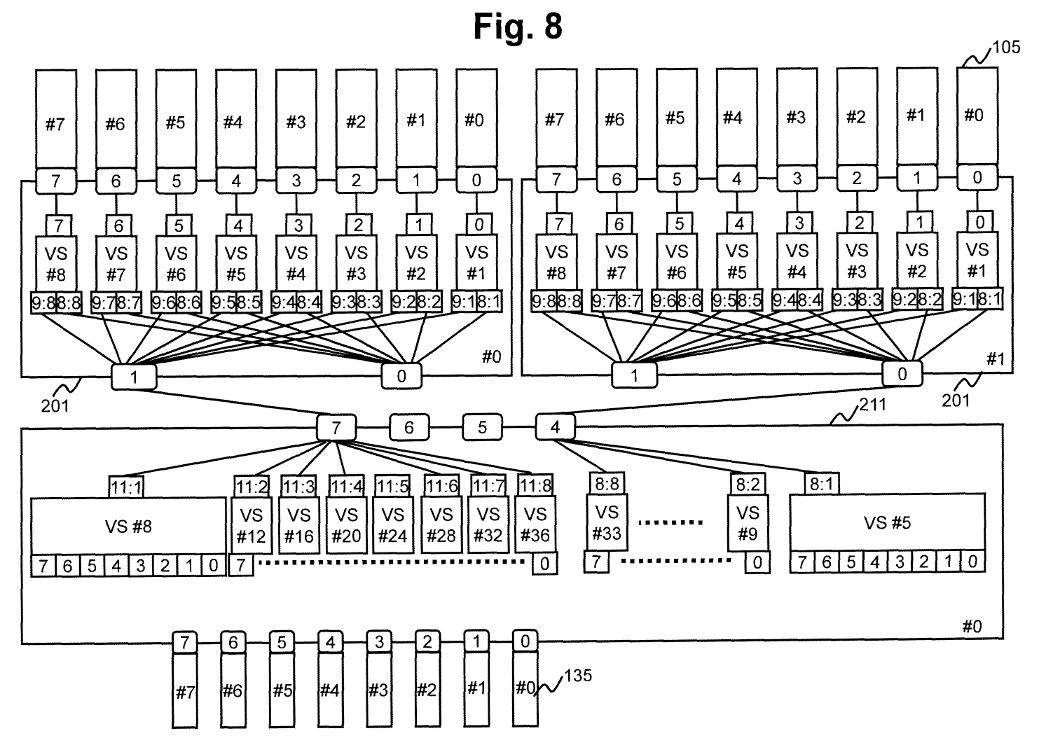

The switch control program 433 sets the upstream setting information 710 (see FIG. 7B) that conforms to the blade/VS correspondence information 700 to the post-stage PCIe switch 211 (for instance, a register (not shown) in the post-stage PCIe switch 211). The post-stage PCIe switch 211 controls a transmission and a reception of the information between the server blade 105 and the I/O card 135 based on the upstream setting information 710. The upstream setting information 710 is provided with the following information for every post-stage VS of the post-stage PCIe switch 211 in the I/O expansion chassis 123 that is provided with the upstream setting information 710:
(*) a post-stage VS #711 that is a number of the post-stage VS;
(*) a post-stage upstream port #712 that represents a number of a post-stage upstream port to which the post-stage VS is coupled; and
(*) a VHN 713 that is a VHN that is associated with a virtual upstream port of the post-stage VS.
   In the present embodiment, a VHN is a value that is obtained by adding 1 to an absolute blade # (the VHN can be equal to the absolute blade #). By setting the upstream setting information 710 to the post-stage PCIe switch 211 as described above, a VHN that is associated with each of the post-stage VS that is coupled to a post-stage upstream port #7 is as shown in FIG. 8. In FIG. 7B and FIG. 8, a server blade #0 in the server chassis #0 is allocated to the post-stage VS #8 and a VHN 1 (a value that is obtained by adding 1 to a number of the server blade) is allocated to the post-stage VS #8 for instance.

The information 711 and the information 712 of the upstream setting information 710 can be set to the post-stage PCIe switch 211 at the time point when a post-stage upstream port and a post-stage VS that is coupled to the post-stage upstream port are decided (this can be similar for all of the post-stage PCIe switches 211). In this case, the VHN 713 can be added to the upstream setting information 710 based on the above described blade/VS correspondence information 700.

In accordance with the above calculation results (shown in FIG. 8 for instance), all of the server blades that are coupled to the pre-stage PCIe switch #0 that is coupled to the post-stage upstream port #7 are allocated to eight post-stage VS that are coupled to the post-stage upstream port #7 on a one-to-one basis. Moreover, an I/O card in the I/O expansion chassis 123 that is provided with the pre-stage PCIe switch #0 can also be coupled to the eight post-stage VS. In other words, a construction of a basic configuration that is provided with a symmetric property is completed.

For the construction of a basic configuration that is provided with a symmetric property, the blade/VS correspondence information 700 (see FIG. 7A) that is related to the post-stage PCIe switch 211 that is coupled to the post-stage controller 213 is set to each of the post-stage controller 213 of the server system, and the upstream setting information 710 (see FIG. 7B) that is related to the post-stage PCIe switch 211 is set to the post-stage PCIe switch 211. More specifically, any one of a plurality of the following methods can be adopted for instance:
(*) One post-stage controller 213 creates the blade/VS correspondence information 700 for all of the post-stage PCIe switches, and each of the post-stage controller 213 sets the upstream setting information 710 to the post-stage PCIe switch that is coupled to the post-stage controller 213 based on the blade/VS correspondence information 700 for every post-stage PCIe switch. More specifically, the configuration setting program 432 decides a post-stage VS that is to be coupled in the post-stage PCIe switch for each of the post-stage upstream port of other post-stage PCIe switch, a post-stage VS, and a server blade that is allocated to the post-stage VS in the server chassis for instance. The configuration setting program 432 transmits the information that conforms to the results of the processing (for instance, the information that includes the blade/VS correspondence information 700) to the post-stage controller 213 that is related to the information, and the post-stage controller 213 sets the upstream setting information 710 to the post-stage PCIe switch that is coupled to the post-stage controller 213 based on the information.
(*) Each of the post-stage controller 213 creates the blade/VS correspondence information 700 for the post-stage PCIe switch that is coupled to the post-stage controller 213, and sets the upstream setting information 710 that conforms to the blade/VS correspondence information 700 to the post-stage PCIe switch 211. More specifically, the switch control program 433 in each of the post-stage controller 213 creates the blade/VS correspondence information 700 by the method for executing a calculation that conforms to the above second calculating formula, and sets the upstream setting information 710 that conforms to the blade/VS correspondence information 700 to the post-stage PCIe switch 211 for instance.

### <(X2) Display of a GUI and a GUI Operation by a Manger>

A GUI program 434 is installed to the management computer 261. The GUI program 434 is a computer program that has been downloaded from the post-stage controller 213. The GUI program 434 can also be downloaded from a program source of other types (such as a Web server) as substitute for the post-stage controller 213.

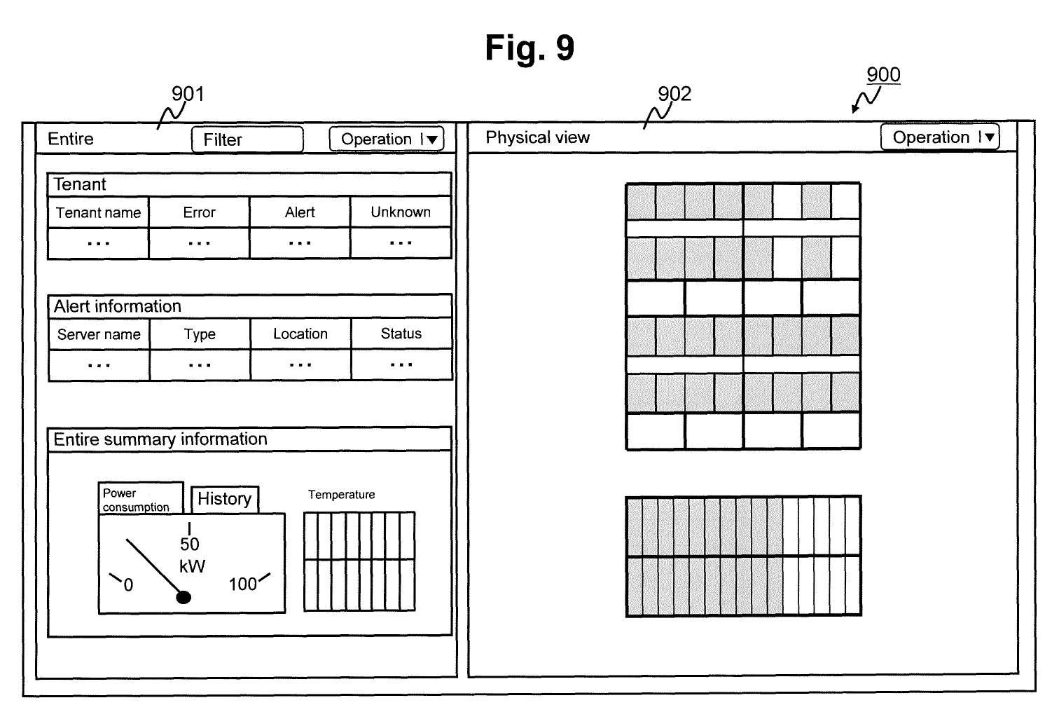

FIG. 9 is a view showing a summary GUI 900.

The GUI program 434 displays the summary GUI 900. The summary GUI 900 is a GUI that displays the information that is related to the summary of the entire server system that is corresponded to a tenant that is desired by a manager (for instance, a tenant to which a manager belongs). By the GUI 900, a manager can execute a brief survey of the server system. The GUI 900 is displayed in the case in which a login is executed by a manager for instance.

The summary GUI 900 is provided with an entire display region 901 and a physical display region 902 for instance.

The entire display region 901 displays the information that indicates a summary of an operation status of the server system (hereafter referred to as the operation summary information). The operation summary information includes the following information for instance;
(*) the alert information that indicates a server blade in which an alert exists; and
(*) the information that indicates a power consumption of the server system and a temperature for every chassis (a server chassis and an I/O expansion chassis).
   In accordance with the information that indicates a temperature, an element (a server blade or an I/O card) in which a temperature is higher for the chassis is displayed in a warmer color.

The operation summary information is the information based on the operation information that is acquired by the pre-stage controller 203 and the post-stage controller 213 for instance. The operation information that is acquired by the pre-stage controller 203 (the information that is stored into the storage resource 404) includes the information that indicates a power consumption and a temperature for every server blade for instance. The operation information that is acquired by the post-stage controller 213 (the information that is stored into the storage resource 424) includes the information that indicates a power consumption and a temperature for every I/O card for instance.

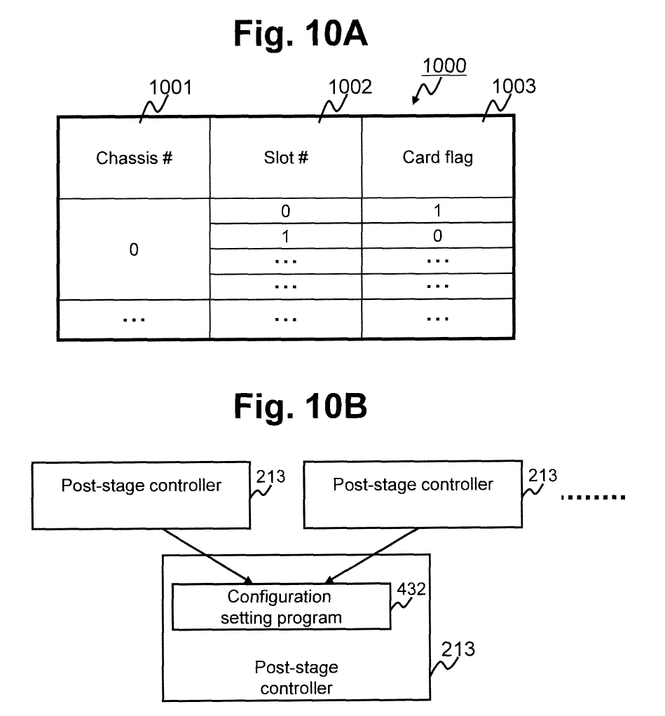

The physical display region 902 displays the information that indicates an external appearance of the server system (hereafter referred to as the appearance information). The appearance information is based on the following information for instance:
(c1) the information that indicates a tenant and a server chassis 113 (or a partition 115) that is corresponded to the tenant (the information is included in the pre-stage configuration information 411 for instance);
(c2) the server blade management information 500 shown in FIG. 5B;
(c3) the information that indicates a tenant and a I/O expansion chassis 123 that is corresponded to the tenant (the information is included in the post-stage configuration information 435 for instance); and
(c4) the I/O card management information 1000 shown in FIG. 10A.
   The I/O card management information 1000 is provided with the following information for every slot 133 for instance:
(*) a chassis #1001 that is a number of the I/O expansion chassis 113 that is provided with the slot 133;
(*) a slot #1002 that is a number of the slot 133; and
(*) a card flag 1003 that indicates whether or not the I/O card 135 has been inserted into the slot 133.
   As shown in FIG. 10B, the configuration setting program 432 in the post-stage controller 213 collects the information that is included in the post-stage configuration information 435 from all of the post-stage controllers 213 by communicating with the switch control program 433 of all of the post-stage controllers 213 via the LAN 251. The configuration setting program 432 constructs the I/O card management information 1000 shown in FIG. 10A in a storage resource 424 based on the collected information.

The above (c1) can also be the information based on the information that has been collected from the pre-stage controller 203, and the above (c3) can also be the information based on the information that has been collected from the post-stage controller 213. In FIG. 10A, the information 1002 and the information 1003 can also be the information that has been acquired from the collected information, and the information 1001 can also be the information that has been identified and added based on the post-stage controller 213 of the collecting source of the information. More specifically, the storage resource 424 in the post-stage controller 213 that is provided with the configuration setting program 432 can store the information that indicates an IP address of the post-stage controller 213 and the I/O expansion chassis 123 in which the post-stage controller 213 exists for instance. Based on the information, the configuration setting program 432 can specify a chassis # that is corresponded to an IP address of the post-stage controller 213 that is a collecting source of the information and can include the specified chassis #511 into the I/O card management information 1000.

The information that has been collected from the pre-stage controller 203 can include the detailed information that is related to the server blade 105 (for instance, the information that indicates a type of the server blade) for every server blade 105. The information that has been collected from the post-stage controller 213 can include the detailed information that is related to the I/O card 135 (for instance, the information that indicates a type of the I/O card 135) for every I/O card 135. The GUI program 434 can change an appearance that is displayed on the physical display region 902 based on the detailed information. By the above configuration, a manager can identify a chassis and a type of a server blade or an I/O card that is inserted into the chassis by the appearance that is displayed on the physical display region 902. In the case in which an element that is desired by a manager (for instance, a chassis, a server blade, or an I/O card) is specified on the physical display region 902, the GUI program 434 displays the detailed information that is related to the element that has been specified.

The entire display region 901 can display a tenant list. In the tenant list, the information that indicates a plurality of tenants can be displayed in a selectable manner. In the case in which a tenant that is desired by a manager is selected from the tenant list, the physical display region 902 can display an appearance of the server system that is corresponded to the tenant that is desired by a manager and can display the information that indicates a summary of an operation status of the server system as the operation summary information. As described above, the summary GUI 900 can be used for a brief survey of the entire of server systems that are corresponded to a plurality of tenants.

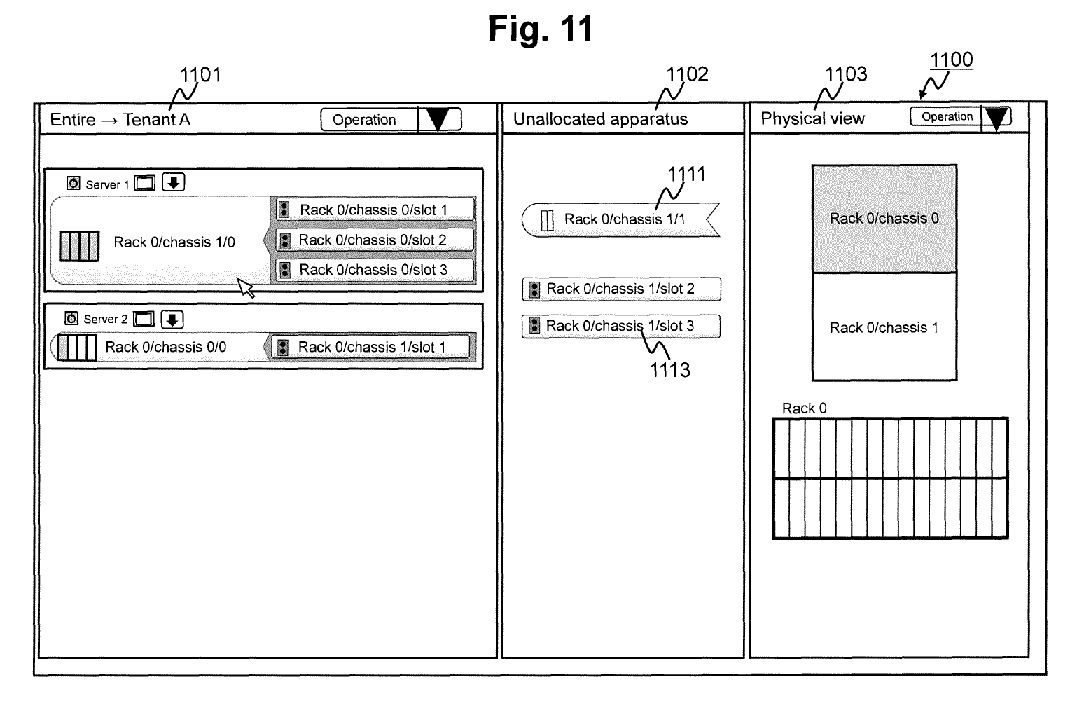

FIG. 11 is a view showing a setting GUI 1100.

The GUI program 434 displays the setting GUI 1100. The setting GUI 1100 is a GUI that is used for allocating an I/O card that is desired by a manager to a partition 115 that is desired by a manager. The GUI 1100 is displayed in the case in which a prescribed operation is executed by the summary GUI 900 for instance.

The setting GUI 1100 is provided with a setting display region 1101, an unallocated display region 1102, and a physical display region 1103 for instance.

The setting display region 1101 displays the following objects:
(*) a partition object (the information that is related to the partition 115) 1111 that is an object that represents the partition 115; and
(*) an I/O card object (the information that is related to the I/O card 135) 1113 that is an object that represents the I/O card 135 that is allocated to the partition 115.
   The objects are objects that have been moved by an operation of a manager (for instance, the drag and drop) from the unallocated display region 1102 as described later. In other words, any object is not displayed in the setting display region 1101 in the first place. Each object is in a rectangle shape for instance. The partition object 1111 in the setting display region 1101 is provided with a region (an I/O card object setting region) 1501 in which the I/O card object 1113 is disposed unlike the partition object 1111 in the unallocated display region 1102. A vertical length of the partition object 1111 is varied depending on the number of the I/O card objects 1113 that are disposed in the region 1501 in the object 1111.

The unallocated display region 1102 displays at least zero object 1111 and/or 1113 that has not been moved to the setting display region 1101 (that is, in the case in which there is not an unallocated partition and/or an I/O card, the unallocated display region 1102 does not display the objects 1111 and/or 1113).

At least two (or one) partition objects 1111 and at least two (or one) I/O card objects 1113 that are displayed in the unallocated display region 1102 in the first place are the objects 1111 and 1113 that represent all of the partitions 115 and all of the I/O cards 135 in the server system. This is because “the basic configuration that is provided with a symmetric property” has already been constructed, whereby any one of the I/O cards 135 can be allocated to the server blade 105 in any one of the partitions 115.

A display of the object 1111 and/or the object 1113 in the unallocated display region 1102 is controlled based on whether or not the key information is associated with the object 1111 and/or the object 1113 by the GUI program 434. The key information is the information that is associated with the information that indicates a partition or an I/O card that is corresponded to the object 1111 or the object 1113 in the case in which the object 1111 or the object 1113 is moved to the setting display region 1101. For instance, in the case in which a first partition object 1111 that is corresponded to a first partition is moved from the unallocated display region 1102 to the setting display region 1101, the key information “server 1” is associated with the information that indicates the first partition by the GUI program 434. Moreover, in the case in which an I/O card object 113 that is corresponded to a first I/O card is moved from the unallocated display region 1102, the key information “server 1” that is equal to the key information that is associated with the information that indicates the first partition is associated with the information that indicates the first I/O card by the GUI program 434. It can be found that since the key information “server 1” is associated with both of the first partition and the first I/O card, the GUI program 434 must display the first partition object 1111 and the first I/O card object 1113 in the setting display region 1101, and the GUI program 434 must display the first I/O card object 1113 in the first partition object 1111. Moreover, in the case in which the key information is associated with a partition and the key information is not associated with an I/O card, the GUI program 434 must display the object 1111 that is corresponded to a partition in the setting display region 1101. However, it is found that any I/O card object 1113 has not been associated with the object 1111. Moreover, it is found that the GUI program 434 must display the object 1111 and the object 1113 that are corresponded to a partition and an I/O card which the key information has not been associated with in the unallocated display region 1102. The information that indicates an association of the key information with the information that indicates a partition or an I/O card (hereafter referred to as the display control information) can be notified of from the GUI program 434 to the configuration setting program 432, and the display control information can be held by a post-stage controller. The GUI program 434 can receive the display control information from the post-stage controller and control a display to the setting GUI 1100.

The partition object 1111 is provided with a mark 1121 that indicates the number of slots 103 that are included in a partition 115 that is corresponded to the object 1111 and a slot 103 to which a server blade 105 has been inserted. A manager can find that the number of server blades 105 that are included in a partition 115 according to the object 1111 and the mark 1121 that is included in the object 1111. A display of the mark 1121 is controlled based on the server blade management information 500 (see FIG. 5B) for instance.

The physical display region 1103 displays a summary of an appearance configuration of the server system. The “summary of an appearance configuration” can be an abstract summary or a concrete summary as compared with an external appearance that is displayed in the physical display region 902 of the summary GUI 900 for instance.

A display in the physical display region 1103 and an operation of a manager can also be cooperated with each other. For instance, in the case in which a manager specifies arbitrary object 1111 or arbitrary object 1113 (for instance, an object 1111 or an object 1113 that is desired by a manager is touched by using a pointing device such as a mouse or a finger of the manager), the information that indicates a partition 115 that is corresponded to the specified object 1111 (or a chassis 113 or a rack 111 that includes the partition 115) or an I/O card 135 that is corresponded to the specified object 1113 (or a chassis 123 or a rack 121 that includes the I/O card 135) (or the information that indicates an external appearance or a location for instance) can be displayed. More specifically, the partition object 1111 is specified for instance, an image that represents a chassis 113 that includes the partition 115 that is corresponded to the object 1111 (an image part that represents a chassis 113 in an image that represents an appearance configuration of the server system) can be highlighted (for instance, the image can be displayed in a mode different from other chassis (for instance, a different color or a different pattern)). Moreover, in the case in which the I/O card object 1113 is specified for instance, an image of a chassis 123 that includes the I/O card 135 that is corresponded to the object 1113 (for instance, an image that has been drawn in detail in such a manner that a slot into which an I/O card has been inserted can be found) can be displayed.

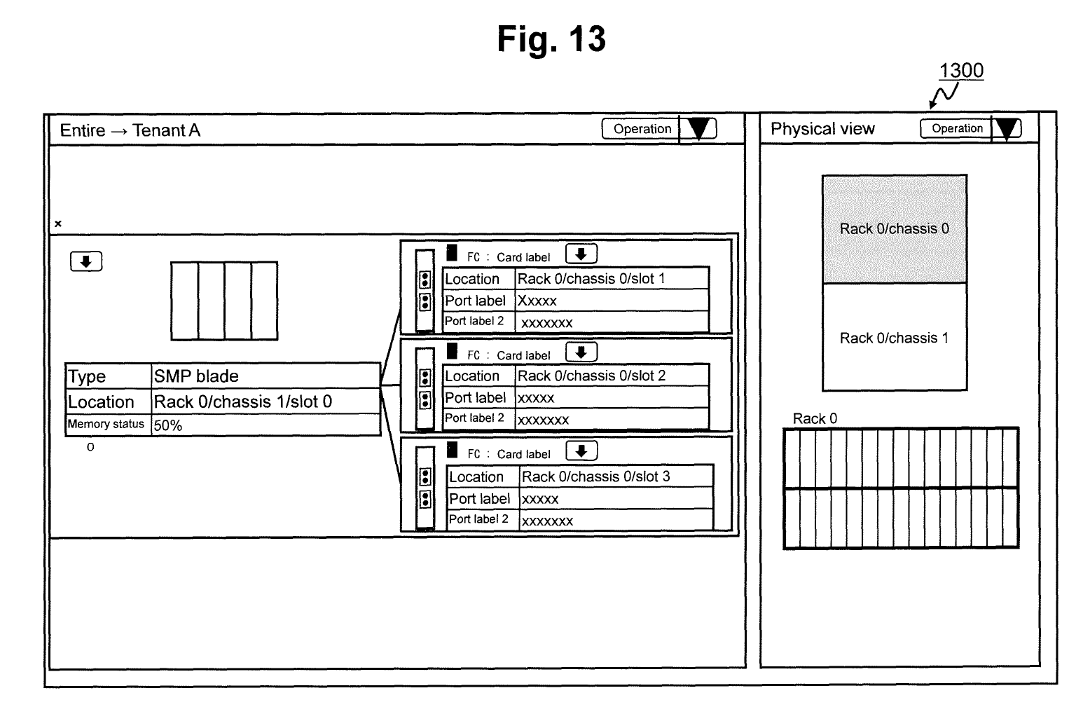

FIG. 13 is a view showing a detailed GUI 1300.

The detailed GUI 1300 is a GUI in which the detailed information that is related to an element of the server system (for instance, an element that has been specified by a manager). The detailed GUI 1300 is displayed in the case in which an element that is desired by a manager is specified by using the summary GUI 900 or the setting GUI 1100 for instance. The “element” that is described here is a rack 111 or 121, a chassis 113 or 123, a partition 115, a server blade 105, or an I/O card 135 for instance. The “detailed information that is related to an element” is the information that indicates a type of an element and a mounted location for instance.

A wide variety of display controls can be executed for at least one of the summary GUI 900, the setting GUI 1100, and the detailed GUI 1300. A display control is not restricted to the configuration that is shown in the figures. For instance, a plurality of GUI displays can be switched in one window. Every when a new GUI is displayed, a window can be newly created and a GUI can be displayed in the window. Moreover, each of the display regions that are included in the GUI can be a window.

The above descriptions are an explanation of an GUI that is displayed.

A manager can operate the setting GUI 1100 to allocate an I/O card 135 to a partition 115. An example of the operation will be described in the following.

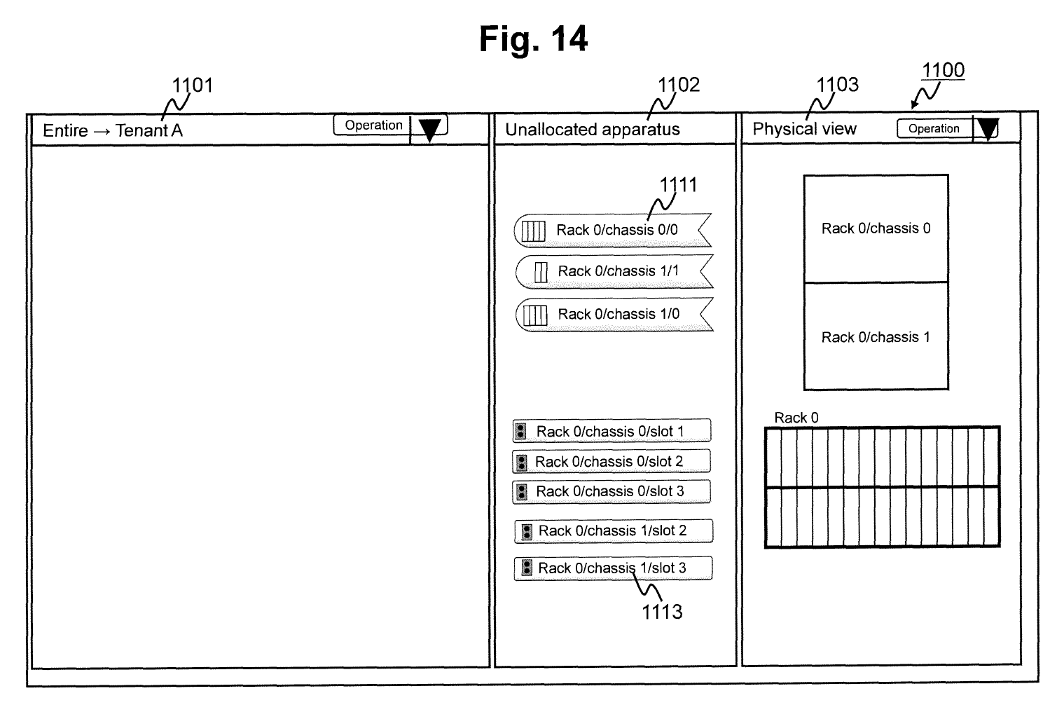

As shown in FIG. 14, any object does not exist in the setting display region 1101 of the setting GUI 1100 that is displayed in the first place. An unallocated display region 1102 of the GUI 1100 displays at least two (or one) partition objects 1111 that are corresponded to all of the partitions 115 that exist in the server system and at least two (or one) I/O card objects 1113 that are corresponded to all of the I/O card 135 that exist in the server system.

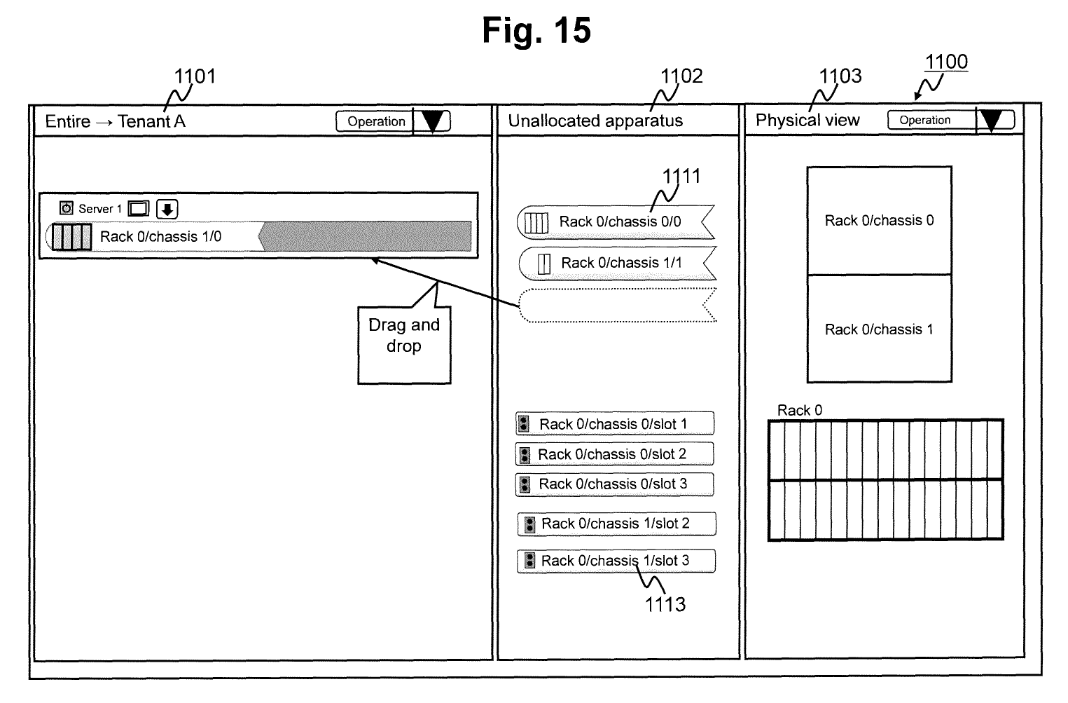

As shown in FIG. 15, a manager moves a partition object 1111 that is corresponded to a partition 115 that is desired (hereafter referred to as a target object in the descriptions of FIG. 15 to FIG. 18) from the unallocated display region 1102 to the setting display region 1101. The movement of the object can be executed by a simple operation (such as the drag and drop of an object). In the case in which the target object 1111 is moved to the setting display region 1101, an I/O card object setting region 1501 is added to the target object 1111 by the GUI program 434.

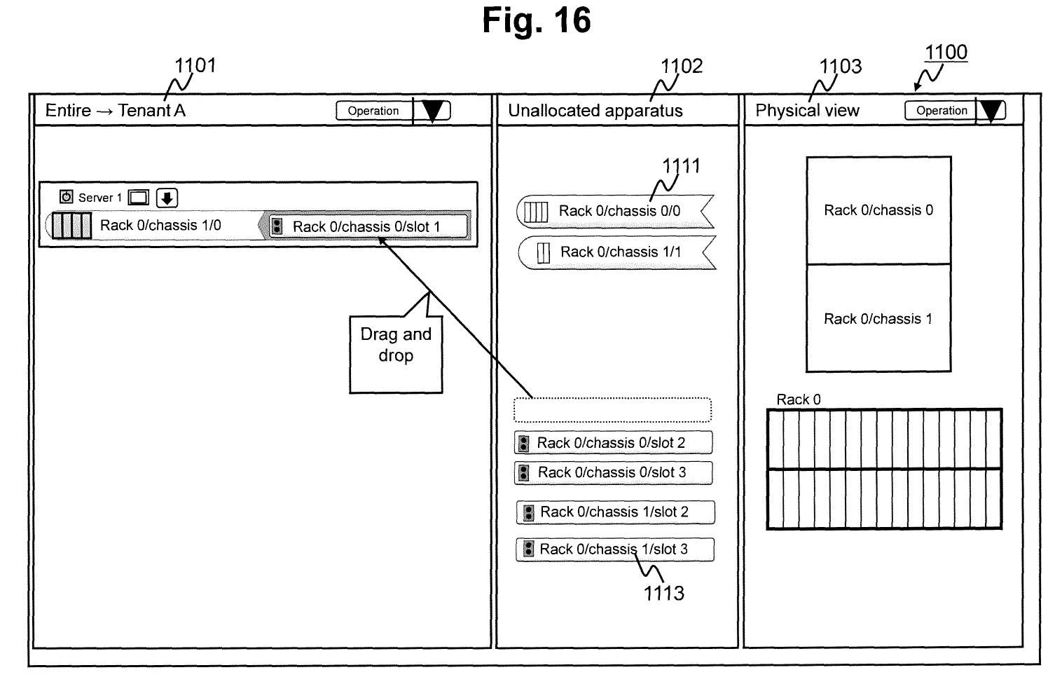

As shown in FIG. 16, a manager moves an I/O card object 1113 that is corresponded to an I/O card 135 that is desired by a manger from the unallocated display region 1102 to the region 1501 in the target object 1111 by the drag and drop or the like. By this operation, the I/O card 135 that is desired by a manger can be allocated to the partition 115 that is corresponded to the target object 1111. However, the setting to the post-stage PCIe switch 211 has not yet been completed. The setting will be executed by “(X3) Information setting that conforms to a GUI operation by a manager” that will be described later. Being cooperated with the GUI operation by a manager, the setting can also be executed to the post-stage controller 213 and/or the post-stage PCIe switch 211 in a sequential manner.

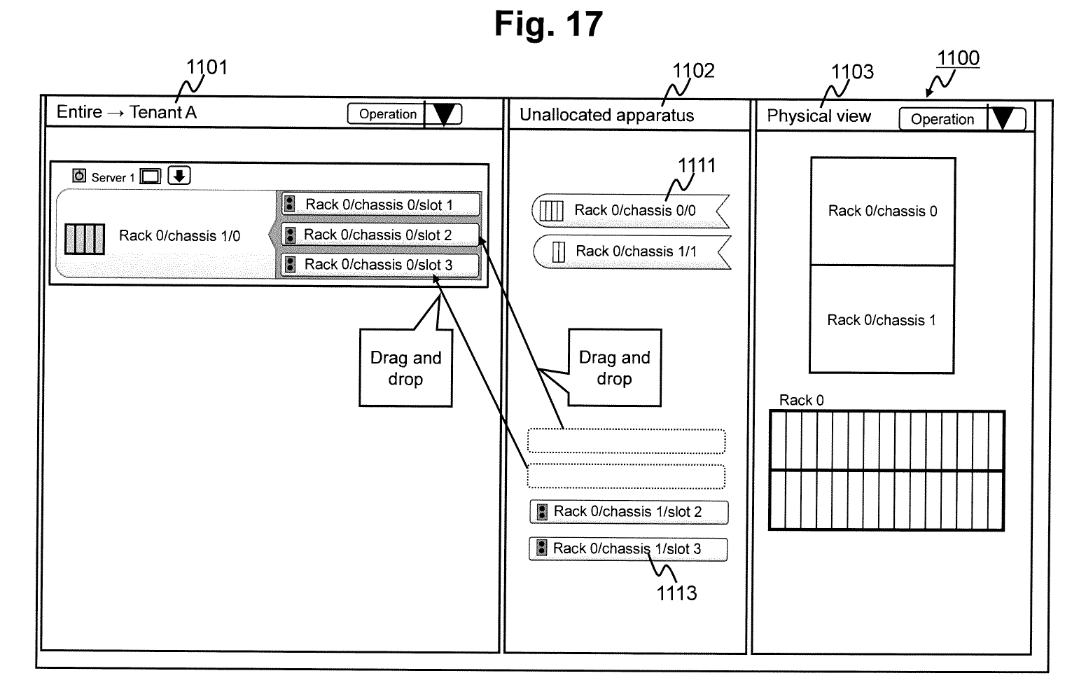

As shown in FIG. 17, a manager can add an I/O card object 1113 that is corresponded to an I/O card 135 that is desired by a manger from the unallocated display region 1102 to the region 1501 in the target object 1111 by the drag and drop or the like.

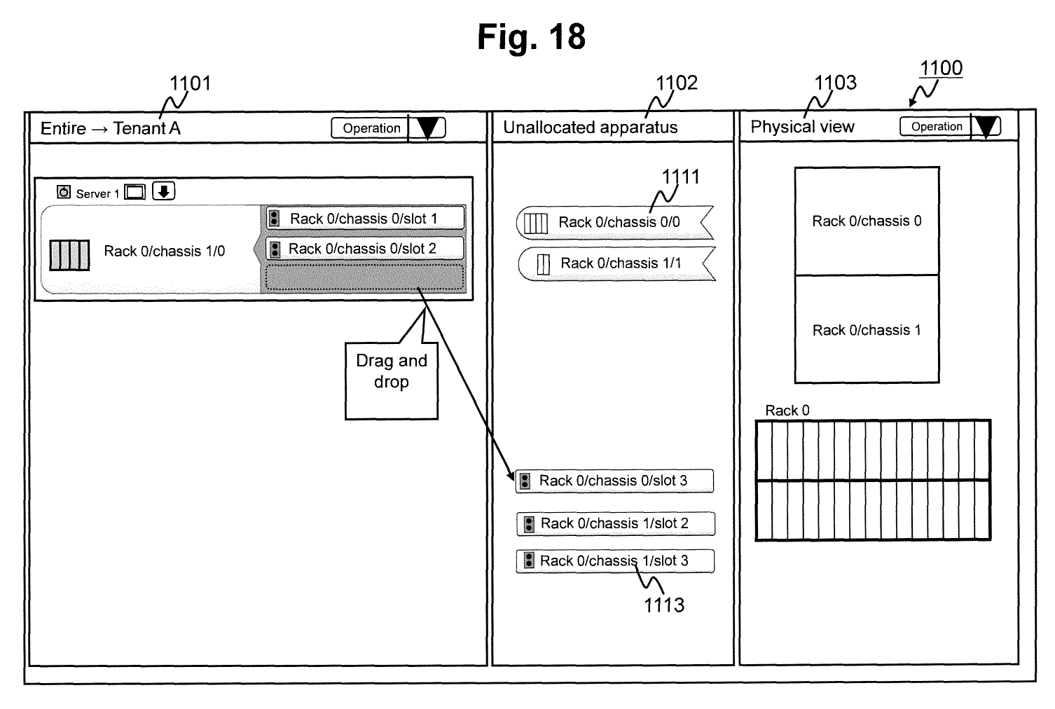

As shown in FIG. 18, a manager can return an I/O card object 1113 that is corresponded to an I/O card 135 that is desired by a manger from the region 1501 in the target object 1111 to the unallocated display region 1102 by the drag and drop or the like. By this operation, the I/O card 135 that is desired by a manger can be removed from the partition 115 that is corresponded to the target object 1111.

As described above, a manager moves an object 1111 that is corresponded to the desired partition 115 to the setting display region 1101, and allocates the object 1113 that is corresponded to the desired I/O card 135 to the object 1111. By this operation, the I/O card 135 that is desired by a manger can be allocated to at least one partition 115 that is desired by a manger.

A manager executes a prescribed operation for constructing the server system to which the allocation has been reflected (for instance, selects a character string of “Setting” from a prescribed pull-down menu of the setting GUI 1100). Corresponding to the operation, the information setting is executed.

<(X3) Information Setting that Conforms to a GUI Operation by a Manager>

In order to construct the server system that conforms to an allocation relationship that has been set to the setting GUI 1100, the information that conforms to the allocation relationship is set to the post-stage PCIe switch 211.

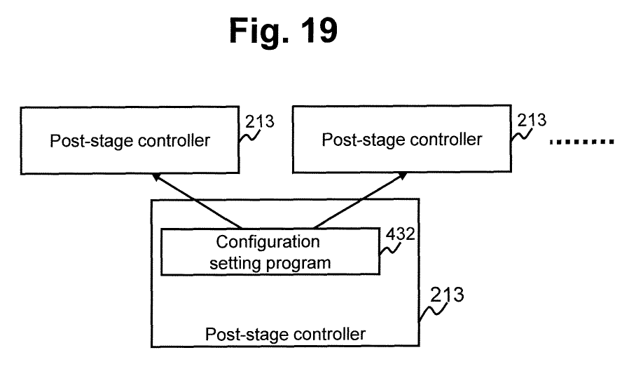

More specifically for instance, the GUI program 434 transmits the information that indicates a correspondence relationship that is displayed in the setting GUI 1100 (a correspondence relationship between the partition 115 and the I/O card 135) (hereafter referred to as the allocation relationship information) to the post-stage controller 213 that is provided with the configuration setting program 432. The allocation relationship information includes the following sub information for every correspondence (set) between the partition 115 and the I/O card 135 for instance:
(*) a number of the partition 115;
(*) a number of the chassis 113 that includes the partition 115;
(*) a number of the I/O card 135; and
(*) a number of the I/O expansion chassis 123 that includes the I/O card 135.
   As shown in FIG. 19, the configuration setting program 432 transmits the sub information that is related to other post-stage controller 213 (the sub information that is related to the I/O card 135 that is coupled to the post-stage PCIe switch 211 that is coupled to other post-stage controller 213) of the allocation relationship information to the post-stage controller 213.

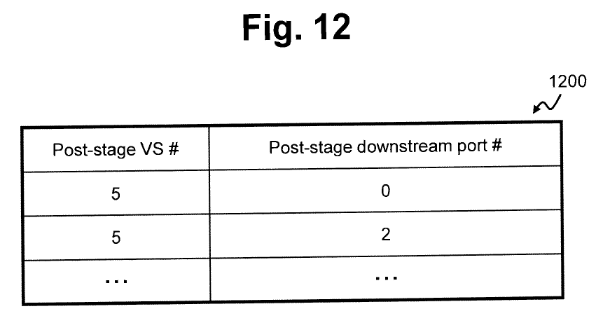

The switch control program 433 sets the information that conforms to the sub information in the allocation relationship information to the post-stage PCIe switch 211. The information that conforms to the sub information is the information that is equal to the downstream setting information 1200 shown in FIG. 12 for instance. In other words, the information is the information that indicates a post-stage VS and an I/O card 135 that has been coupled to the post-stage VS.

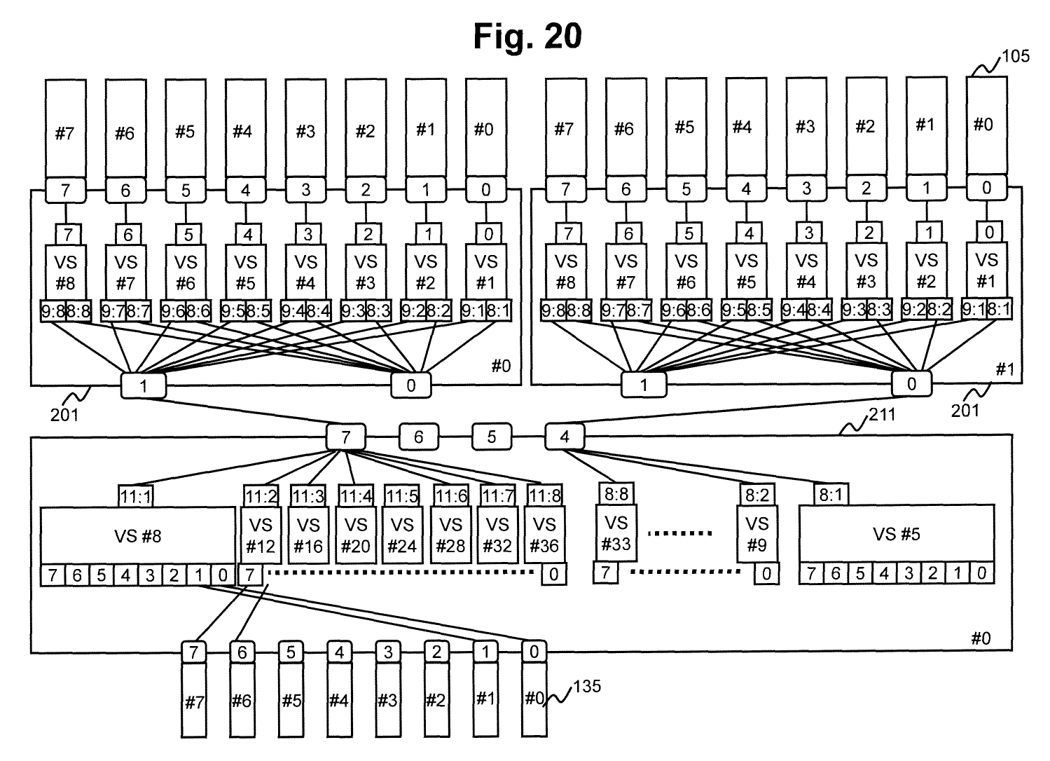

By executing the above setting, the I/O card 135 is coupled to the virtual downstream port of the post-stage VS as shown in FIG. 20.

For which I/O card 135 of at least two (or one) I/O cards 135 that are desired by a manager is allocated to which server blade 105 of at least one server blade 105 in the partition 115 that is desired by a manager, a manager can specify a server blade 105 to be allocated for every I/O card 135 in the partition 115 by using a GUI (not shown), or a server blade 105 in the partition 115 can be automatically decided by the switch control program 433. For instance, a virtual downstream port that is included in a post-stage VS which an I/O card 135 is coupled can be decided based on a number of a server blade 105 in the partition 115 to which the I/O card 135 has been allocated, a number of the I/O card 135, and a number of the virtual downstream port. Moreover, in the case in which there is a plurality of server blades 105 in the partition 115 and a plurality of I/O cards 135 are allocated to the partition 115, all of the I/O cards 135 can be allocated to the server blades 105 of a relative slot number of 0 in the partition 115. Alternatively, a plurality of I/O cards 135 can be distributed to a plurality of server blades 105 in an even manner. For instance, in the case in which there are two server blades 105 and six I/O cards 135, three I/O cards 135 are allocated to each of the server blades 105.

More specifically, in the case in which there are server blades #0 and #1 in the partition 115 in the chassis #0 and four I/O cards #0, #1, #6, and #7 are allocated to the partition 115, the following processing can be executed:
(*) The switch control program 433 decides a server blade and an I/O card that is allocated to the server blade (for instance, the switch control program 433 decides the number of I/O cards per one server blade) based on the number of server blades 105 in the partition 115 and the number of I/O cards 135 that are allocated to the partition 115. Here for instance, the switch control program 433 decides that the I/O cards #0 and #1 are allocated to the server blade #0 and the I/O cards #6 and #7 are allocated to the server blade #1.
(*) The switch control program 433 decides a post-stage VS #8 that has been allocated to the server blade #0 and a post-stage PCIe switch VS #12 that has been allocated to the server blade #2 based on the upstream setting information 700 (see FIG. 7A).
(*) The switch control program 433 sets the setting information in which the I/O card #0 is coupled to the virtual downstream port #0 of the post-stage VS #8, the I/O card #1 is coupled to the virtual downstream port #1 of the post-stage VS #8, the I/O card #6 is coupled to the virtual downstream port #6 of the post-stage VS #12, and the I/O card #7 is coupled to the virtual downstream port #7 of the post-stage VS #12 to the post-stage PCIe switch 211 (see FIG. 20). A number of a virtual downstream port of a coupling destination of the I/O card 135 is decided in an unambiguous manner in accordance with a prescribed rule (such as a calculating formula) based on a number of the I/O card 135 (a number of the post-stage downstream port to which the I/O card 135 is coupled). For instance, a number of a virtual downstream port of a coupling destination of the I/O card 135 can be equivalent to a number of the I/O card 135 (a number of the post-stage downstream port to which the I/O card 135 is coupled).

A construction of a server system is completed and the server system can be operated by executing the above (X1) Construction of a basic configuration that is provided with a symmetric property, (X2) Display of a GUI and a GUI operation by a manger, and (X3) Information setting that conforms to a GUI operation by a manager.

In accordance with the present embodiment, by constructing a basic configuration that is provided with a symmetric property, an operation that is necessary for a manager to construct an I/O configuration of the server system is only a specification of a desired partition 115 and a specification of a desired I/O card 135 in essence. More specifically for instance, a partition object and an I/O card object are displayed in the GUI 1100, and a manager can execute a simple operation to associate a desired I/O card object with a desired partition object. In other words, a PCIe switch is hidden to a manager. Consequently, even in the case in which a manager does not know a detailed setting of a PCIe switch, the manager can allocate (couple) an I/O card 135 that is desired by a manager to a server blade 105 in a partition 115 that is desired by a manager.

A flow of an I/O of the information that is executed for the server system has already been known.

In the example shown in FIG. 20 for instance, in the case in which a server blade # in the chassis #0 outputs a command (a packet), a post-stage VS #1 adds a VHN “1” to the command and outputs the command. The command with the VHN “1” is transmitted to the post-stage VS #8 that is corresponded to the VHN “1” via a pre-stage downstream port #1 and a post-stage upstream port #7. The post-stage VS #8 removes the VHN “1” from the command and transmits the command to the I/O card #0 that is corresponded to the VHN “1” (a server blade #0). The command is output from the I/O card #0 to an address of the command. In the case in which the command is an I/O command, the I/O command is transmitted to a storage apparatus that is coupled to the I/O card #0 (such as a disk array apparatus) for instance.

In the example shown in FIG. 20 for instance, in the case in which the I/O card #0 receives a response of the I/O command (for instance, a write completion report or the read target data), the response is transmitted to the post-stage VS #8. The post-stage VS #8 adds a VHN “1” to the response and outputs the response with the VHN “1” from a virtual upstream port. The response with the VHN “1” is transmitted to the pre-stage VS #1 that is corresponded to the VHN “1” via a post-stage upstream port #7 and a pre-stage downstream port #1. The pre-stage VS #1 removes the VHN “1” from the response and transmits the response to a server blade #0.

<Modification of an Allocation of an I/O Card 135 in Accordance with a Configuration Modification of a Partition>

A manager can operate a prescribed GUI (such as a setting GUI 1100) to modify a configuration of a desired partition 115. More specifically, a manager can increase or decrease the number of server blades 105 that configure an SMP group.

As described above, the SMP group is a group of at least one server blade 105 in which an SMP connection has been executed, that is, a group of at least one server blade 105 that configures a scale-up server. By the SMP connection, at least two server blades 105 of a plurality of server blades 105 are combined to be one, and a server group that is configured by the at least two server blades 105 functions as a server blade with a performance higher than that of one server blade. In other words, a scale-up server can be implemented.

The SMP connection is implemented as described in the following for instance.

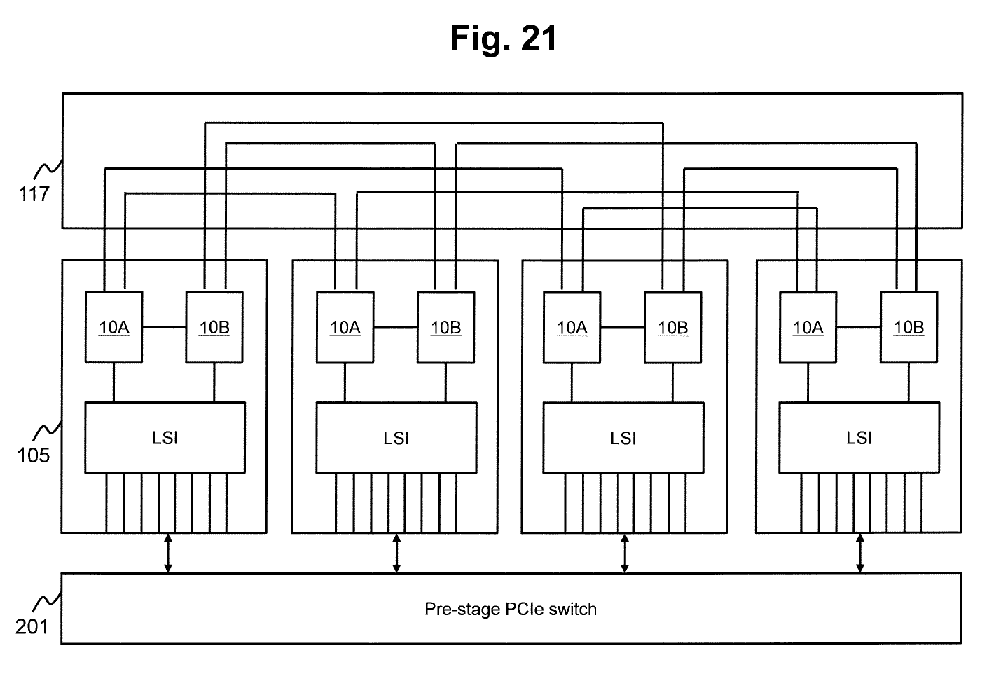

As shown in FIG. 21, four server blades 105 exist in one partition 115. Each of the server blades 105 is coupled to two other server blades 105 in the partition 115 via a front plane 117.

Each of the server blades 105 is provided with a first processor 10A and a second processor 10B (such as a CPU). The first processor 10A is coupled to a first processor 10A of two other server blades 105, and the second processor 10B is coupled to a second processor 10B of two other server blades 105. A path that couples the first processors 10A to each other and/or a path that couples the second processors 10B to each other are connected or disconnected in a logical manner, whereby the number of server blades 105 that configure an SMP group can be increased or decreased.

The SMP connection can utilize the technology that is disclosed in Japanese Patent No. 4484757 or the technology that is disclosed in Japanese Patent Application Laid-Open Publication No. 2010-079467.

<Processing that is Executed in the Case in which the Number of Server Blades 105 that Configure an SMP Group is Decreased>

In the case in which the number of server blades 105 that configure an SMP group is decreased, each of at least one I/O card 135 that has been allocated to at least one server blade 105 that has been decreased is allocated to any one of the server blades 105 that configure an SMP group. For instance, at least one I/O card 135 that has been allocated to at least one server blade 105 that has been decreased can be distributed to at least one server blade 105 that configures an SMP group in an even manner.

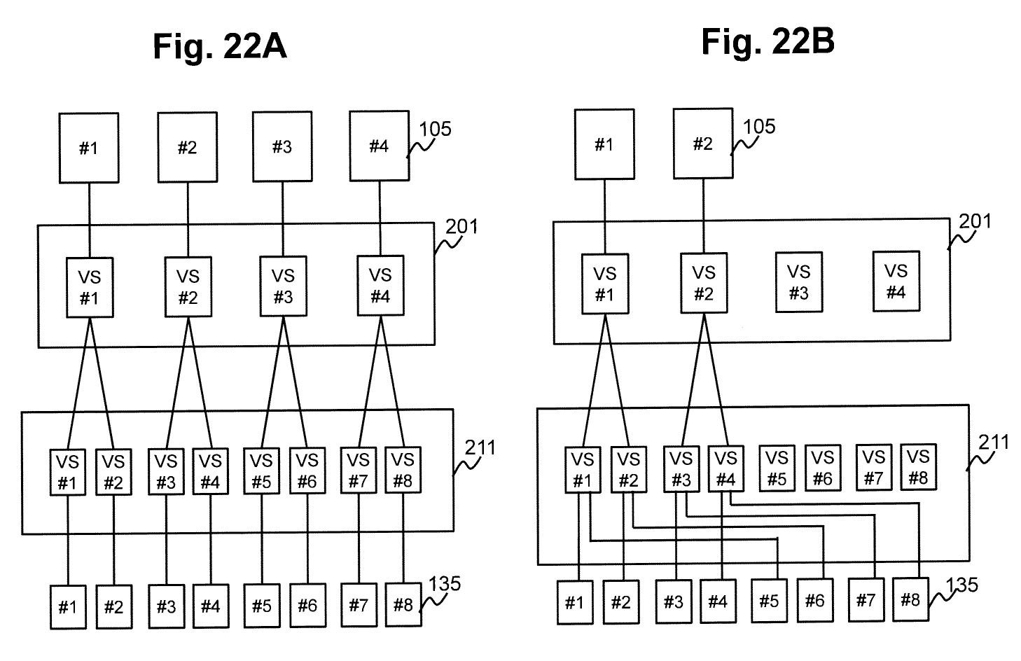

More specifically for instance, as shown in FIG. 22A, the SMP group is configured by four server blades #1 to #4, and two different I/O cards are allocated to each of the server blades. As shown in FIG. 22B, two server blades #3 and #4 are reduced from the SMP group. In this case, as shown in FIG. 22B, the switch control program 433 (or the configuration setting program 432) distributes the I/O cards #5 to #8 that have been allocated to two server blades #3 and #4 to the server blades #1 and #2 in an even manner. For instance, two I/O cards #5 and #6 are allocated to the server blade #1 and two other I/O cards #7 and #8 are allocated to the server blade #2. More specifically, the switch control program 433 (or the configuration setting program 432) executes the following processing:
(*) couples the I/O card #5 to a free virtual downstream port of the post-stage VS #1 that has been allocated to the server blade #1;
(*) couples the I/O card #6 to a free virtual downstream port of the post-stage VS #2 that has been allocated to the server blade #1;
(*) couples the I/O card #7 to a free virtual downstream port of the post-stage VS #3 that has been allocated to the server blade #2; and
(*) couples the I/O card #8 to a free virtual downstream port of the post-stage VS #4 that has been allocated to the server blade #2.
   In the case in which there in no free virtual downstream port in the post-stage VS that is to be a coupled destination of an I/O card, the switch control program 433 (or the configuration setting program 432) can couple an I/O card to a virtual downstream port of other post-stage VS that has been allocated to a server blade that configures the SMP group.
   <Processing that is Executed in the Case in which the Number of Server Blades 105 that Configure an SMP Group is Increased>

In the case in which the number of server blades 105 that configure an SMP group is increased, the switch control program 433 (or the configuration setting program 432) judges whether or not “x” server blades 105 that are not being operated exist in the first partition 105 that includes the SMP group. For instance, “x” is a value that is obtained by subtracting the number “z” of server blades that configure the SMP group before a configuration modification from the number “y” of server blades that configure the SMP group after a configuration modification (that is, the increasing number of server blades 105). The switch control program 433 (or the configuration setting program 432) can judge whether or not each of the server blades are being operated based on the operation information that is included in the information that is collected from the pre-stage controller 203 (the information that includes the information that indicates whether or not each of server blades in each of the partitions is being operated) for instance.

In the case in which it is judged that “x” server blades 105 that are not being operated exist in the first partition 105, the switch control program 433 (or the configuration setting program 432) adds “x” server blades 105 to the SMP group and allocates at least one I/O card that has been allocated to the SMP group to all of the server blades of the SMP group after a configuration modification in an even manner. For instance, in the case in which the SMP group before a configuration modification is configured by two server blades, four I/O cards are allocated to the two server blades, and the SMP group after a configuration modification is configured by four server blades, the four I/O cards are allocated to the four server blades on a one-to-one basis.

In the case in which it is judged that “x” server blades 105 that are not being operated do not exist in the first partition 105, the switch control program 433 (or the configuration setting program 432) searches other partitions in which the server blades 105 of a number that is equivalent to a number “y” of server blades that configure the SMP group after a configuration modification are not being operated. In the case in which the second partition is found as such a partition, the switch control program 433 (or the configuration setting program 432) allocates all of the I/O cards that have been allocated to the first partition to “y” server blades that are not being operated in the second partition.

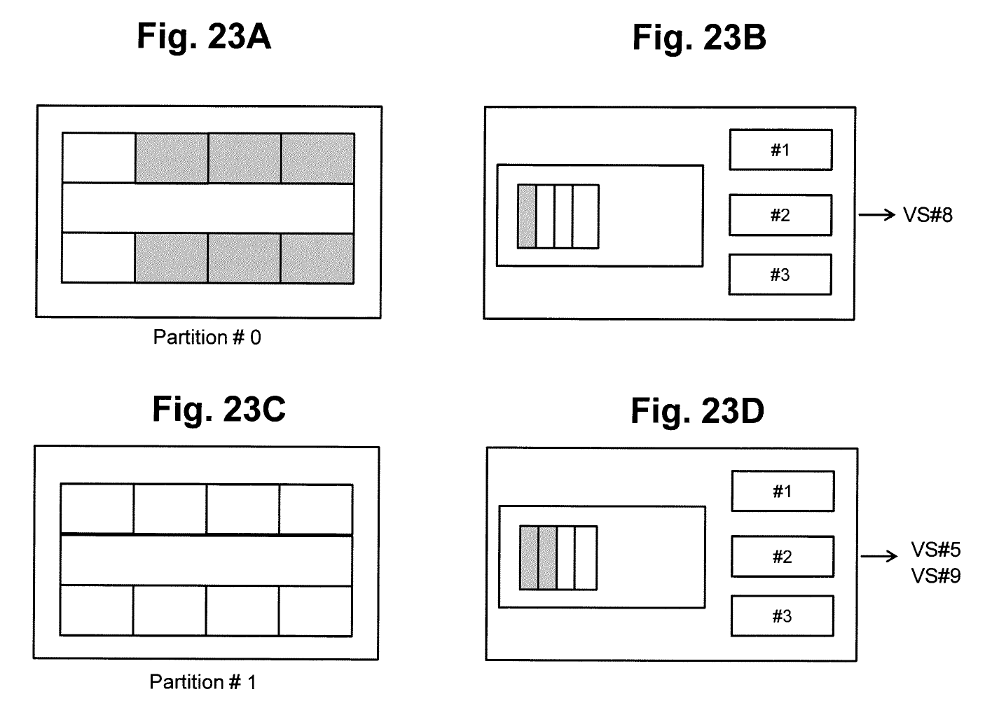

More specifically for instance, as shown in FIG. 23A, the SMP group is configured by one server blade #0 for the first partition in the chassis #0, and there is no server blade that are not being operated in the first partition #0. Moreover, as shown in FIG. 23B, the I/O cards #1 to #3 are allocated to the first partition #0. The coupled destination of the I/O cards #1 to #3 is a post-stage VS #8 that has been allocated to the server blade #0.

Even in the case in which the number of SMP groups is wanted to be increased to be 2, a server blade of the first partition #0 cannot be added.

A partition that is provided with at least two server blades that are not being operated is searched based on the information that has been collected from all of the pre-stage controllers for instance. As such a partition as shown in FIG. 23C, a second partition #1 in the chassis #0 is found. In this case, the switch control program 433 (or the configuration setting program 432) configures the SMP group by two server blades #0 and #1 in the second partition #1 and allocates the I/O cards #1 to #3 to the two server blades #0 and #1 in the second partition #1 (the two server blades #0 and #1 that configure the SMP group) as substitute for the first partition #0. More specifically for instance, as shown in FIG. 23B and FIG. 23D, a coupled destination of the I/O cards #1 to #3 is modified from the post-stage VS #8 to the post-stage VS #5 and #9 (two post-stage VS that have been allocated to the server blades #0 and #1 in the second partition #1). The switch control program 433 (or the configuration setting program 432) updates the information 1200 that has been set to the post-stage PCIe switch 211 (see FIG. 12) in accordance with the above modification.

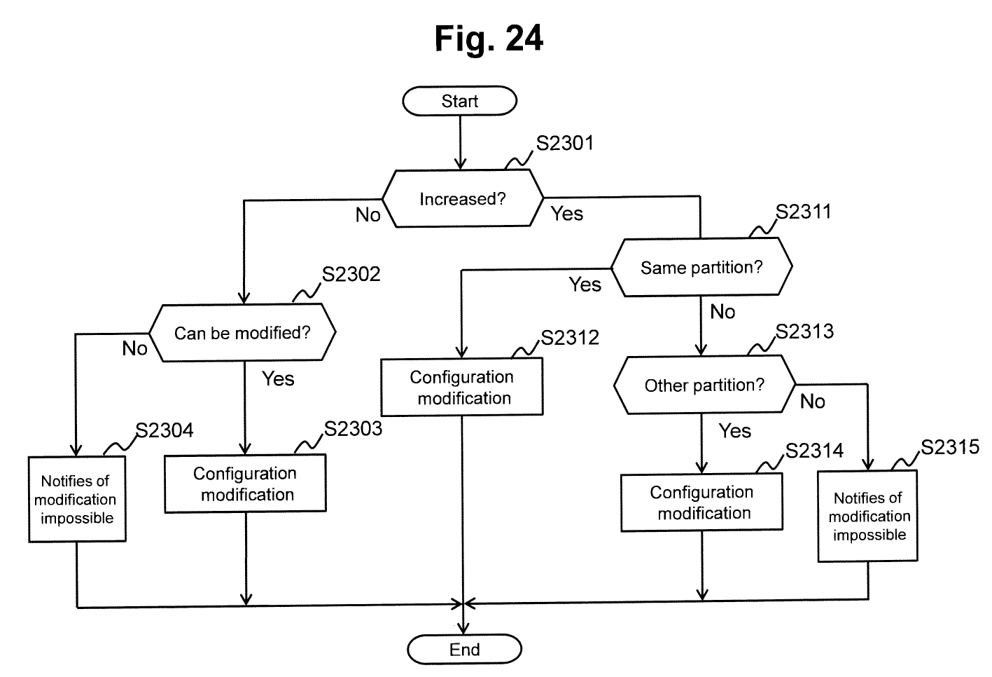

In accordance with the descriptions with reference to FIG. 21 to FIG. 23D, the switch control program 433 (or the configuration setting program 432) can execute the partition configuration modification processing shown in FIG. 24 for instance.

More specifically, in the case in which the program 433 (or the program 432) receives a request of a configuration modification of a partition (a configuration modification of the SMP group) from a manager, the program 433 (or the program 432) judges whether or not the request is an increase or a decrease in the number of server blades that configure the SMP group in the S2301.

In the case in which the result of the judgment of the S2301 is negative (that is, in the case in which the request from a manager indicates a decrease in the number of server blades that configure the SMP group), the program 433 (or the program 432) judges whether or not a configuration modification is possible in the S2302. For instance, in the case in which there are free virtual downstream ports of the number that is equivalent to that of I/O cards that have been allocated to at least one server blade that is to be decreased in at least one post-stage VS that has been allocated to all of the server blades that configure the SMP group after a configuration modification (the server blades after an decrease), the result of the judgment of the S2302 is positive.

In the case in which the result of the judgment of the S2302 is positive, the program 433 (or the program 432) executes a configuration modification in the S2303. In other words, the program 433 (or the program 432) couples an I/O card that has been allocated to at least one server blade that is to be decreased to at least one post-stage VS that has been allocated to all of the server blades that configure the SMP group after a configuration modification (the server blades after an decrease). In this configuration modification, the information 1200 that has been set to the post-stage PCIe switch is updated (see FIG. 12).

In the case in which the result of the judgment of the 52302 is negative, the program 433 (or the program 432) displays the information that indicates that a configuration modification is impossible by the GUI program 434 in the S2304.

In the case in which the result of the judgment of the S2301 is positive, the program 433 (or the program 432) judges whether or not a configuration modification is possible in the same partition (the first partition) in the S2311. More specifically, the program 433 (or the program 432) judges whether or not a server blade that is not being operated of the increased number exist in the partition in which a configuration modification is specified (the first partition).

In the case in which the result of the judgment of the S2311 is positive, the program 433 (or the program 432) executes a configuration modification in the S2312. In other words, the program 433 (or the program 432) can modify an allocation destination of an I/O card that is a part of at least one I/O card that has been allocated to all of the server blades that configure the SMP group before a configuration modification from an existing server blade to a server blade that has been newly added to the SMP group. In this configuration modification, the information 1200 that has been set to the post-stage PCIe switch is updated (see FIG. 12).

In the case in which the result of the judgment of the 52311 is negative, the program 433 (or the program 432) judges whether or not server blades that is not being operated of the number of blades after a configuration modification exist in other partition in the S2313.

In the case in which the result of the judgment of the S2313 is positive, the program 433 (or the program 432) executes a configuration modification in the S2314. In other words, the program 433 (or the program 432) allocates all of the I/O cards that have been allocated to the SMP group before a configuration modification in the first partition to a server blade that is a member of the SMP group after a configuration modification in other partition that has been found (the second partition). In this configuration modification, the information 1200 that has been set to the post-stage PCIe switch is updated (see FIG. 12).

In the case in which the result of the judgment of the S2313 is negative, the program 433 (or the program 432) displays the information that indicates that a configuration modification is impossible by the GUI program 434 in the S2315.

While the preferred embodiments in accordance with the present invention have been described above, the present invention is not restricted to the embodiments, and various changes, modifications, and functional additions can be thus made without departing from the scope of the present invention as a matter of course.

In the above embodiment for instance, a server blade 105 is specified in a unit of a partition 115. However, the server blade 105 can also be specified in other unit (such as a unit of a rack 111 and a unit of a server blade 105) (for instance, an object is in a unit of a server blade). Moreover, an I/O card 135 can also be specified in a prescribed unit (such as a unit of a rack 123 and a unit of a chassis 123) as substitute for that an I/O card 135 is individually specified.

Moreover, an I/O switch of other type can also be adopted as substitute for a PCIe switch.

Moreover, a management system can be provided with a management server that relays a communication between a management computer 261 and a post-stage controller 213 in addition to the management computer 261.

A plurality of server blades 105 of different types can also be coupled to at least one pre-stage PCIe switch 201. Moreover, a plurality of I/O cards 135 of different types can also be coupled to at least one post-stage PCIe switch 211.

Whether or not a server blade or an I/O card is unallocated can be found by whether or not an object is displayed in an unallocated display region 1102. As substitute for that, whether or not a server blade or an I/O card is unallocated can also be indicated by varying a display mode (such as a color and a width of a line) of an object. In this case, it is not necessary that a display region is divided into a setting display region 1101 and an unallocated display region 1102.

What is claimed is:

1. A server system comprising:
a plurality of servers that configure at least one server unit;
at least one first I/O switch to which the plurality of servers is coupled;
a plurality of I/O devices that configure at least one I/O device unit;
at least one second I/O switch to which the plurality of I/O devices and the at least one first I/O switch are coupled; and
a controller that is coupled to the second I/O switch and a management system, wherein the management system is provided with:
a display part;
an input part; and
a control part that is configured to display the information that indicates the at least one server unit and the at least one I/O device unit on the display part in which a server unit or an I/O device unit of the at least one server unit and the at least one I/O device unit that are indicated by the displayed information is specified from the input part,
(A) the controller executes a setting in which all servers that are coupled to the first I/O switch can be coupled to all I/O cards that are coupled to the at least one second I/O switch that is coupled to the first I/O switch;
(B) the controller receives the information that indicates a server unit that is specified by the input part and an I/O device unit that is specified by the input part and that is allocated to the server unit for the control part from management system; and
(C) the controller executes a setting in which at least one I/O device that configures the specified I/O device unit is allocated to at least one server that configures the specified server unit to the second I/O switch to which the at least one I/O device is coupled based on the information that has been received in the (B).

2. A server system according to claim 1, wherein:
the second I/O switch is provided with a plurality of upstream ports, a plurality of virtual switches, and a plurality of downstream ports,
the upstream port is a communication port to which the first I/O switch can be coupled,
the downstream port is a communication port to which the I/O device can be coupled,
the virtual switch is a virtual I/O switch,
at least one specific virtual switch that is virtual switches of the number equivalent to that of servers that are coupled to a first I/O switch is coupled to the upstream port to which the first I/O switch is coupled, and
the controller selects a specific virtual switch that is allocated to a server from the at least one specific virtual switch based on the identification information of the server that is coupled to the first I/O switch, and allocates the selected specific virtual switch to the server in the setting of the (A).

3. A server system according to claim 2, wherein:
the identification information of the server is an identification number of the server, and
the controller executes a calculation in accordance with a specific calculation formula by using the identification number of the server to calculate the identification number of the specific virtual switch that is allocated to the server in the (A).

4. A server system according to claim 3, further comprising at least one chassis, wherein a plurality of servers and the first I/O switch that is coupled to the servers are mounted on the chassis, and
the identification number of the server is provided with an identification number of the chassis and an in-chassis server identification number that is an identification number that can uniquely specify a server for the chassis.

5. A server system according to claim 4, wherein:
the controller selects one calculation formula from a plurality of calculation formulas by using the identification number of the chassis, and calculates an identification number of the specific virtual switch by using the selected calculation formula and the in-chassis server identification number in the (A).

6. A server system according to claim 1, wherein:
the control part displays a GUI (Graphical User Interface) on the display part, and
the GUI is provided with the information that indicates the at least one server unit and the at least one I/O device unit.

7. A server system according to claim 6, wherein:
the GUI is provided with at least one server object that is corresponded to the at least one server unit and at least one I/O device object that is corresponded to the at least one I/O device unit and that can be allocated to any of the server objects, and
the information that is received by the controller in the (B) is the information that indicates a server unit that is corresponded to the server object to which the I/O device object is allocated for the GUI and an I/O device unit that is corresponded to the I/O device object.

8. A server system according to claim 7, wherein:
the GUI is provided with a first display region and a second display region, the second display region is provided with a server object that is corresponded to a server unit that has not been allocated and an I/O device object that is corresponded to an I/O device unit that has not been allocated,
the control part receives from the input part:
(x) a first input in which a region of at least one server object of server objects that are displayed in the second display region is changed from the second display region to the first display region; and
(y) a second input in which a region of at least one I/O device object of I/O device objects that are displayed in the second display region is changed from the second display region to the first display region,
(F) the control part virtually displays a connection of a server object of which a region is changed to the first display region and an I/O device object of which a region is changed to the first display region in the GUI,
(G) the control part receives a decision input that is an input in which the virtually displayed connection is decided from the input part, and
the controller executes a setting in which the I/O device object of which a region is changed to the first display region is allocated to the server object of which a region is changed to the first display region to a second I/O switch to which an I/O device object that is moved to the first display region is coupled based on the information that has been received in the (B).

9. A server system according to claim 7, wherein:
the GUI is provided with a third display region,
the third display region is provided with a server system image that is an image that indicates a physical configuration of the server system, and
in the case in which a server object or an I/O device object in the first display region or the second display region is specified by the input part, the control part displays a part that is corresponded to the selected server object or I/O device object in the server system image by a mode that is different from other parts in the server system image.

10. A server system according to claim 1, wherein:
a scale-up server is configured by at least two servers of a plurality of servers that configure the server unit, and
the controller receives an indication for executing a configuration modification for reducing the number of servers that configure the scale-up server from the management system and allocates at least one I/O device that has been allocated to the at least one server that is reduced to at least one server other than the at least one server that is reduced of the scale-up server.

11. A server system according to claim 10, wherein:
each of the second I/O devices is provided with a plurality of virtual switches to which a plurality of servers is allocated,
the virtual switch is a virtual I/O switch and is provided with a plurality of virtual downstream ports, and the I/O device is allocated to the virtual downstream port,
(y1) the controller receives an indication for executing a configuration modification for reducing the number of servers that configure the scale-up server from the management system;
(y2) the controller judges whether or not there are free virtual downstream ports of the number equal to or larger than the number of I/O devices that have been allocated to the at least one server that is reduced in at least one virtual switch that has been allocated to at least one server other than the at least one server that is reduced;
(y3) in the case in which the result of the judgment of the (y2) is positive, the controller allocates the I/O device that has been allocated to the at least one server that is reduced to a free virtual downstream ports of at least one virtual switch that has been allocated to at least one server other than the at least one server that is reduced; and
(y4) in the case in which the result of the judgment of the (y2) is negative, the controller transmits the information that indicates that at least one server cannot be reduced from the scale-up server to the management system.

12. A server system according to claim 1, wherein:
a scale-up server is configured by at least one server of a plurality of servers that configure the server unit, and
(z1) the controller receives an indication for executing a configuration modification for increasing the number of servers that configure the scale-up server from the management system;
(z2) the controller judges whether or not there are un-operated servers of the number that is equal to the increasing number of the servers;
(z3) in the case in which the result of the judgment is negative, the controller searches a server unit that is provided with un-operated servers of the number that is equal to the number of the servers that configure the scale-up server after the configuration modification from other at least one server unit; and
(z4) in the case in which a corresponding server unit is found in the (z3), the controller constructs the scale-up server by at least two servers of a plurality of servers that configure the server unit, and allocates an I/O device that has been allocated to the at least one server that configures the scale-up server before the configuration modification to the at least two servers.

13. A construction method for an I/O configuration of a server system in which a plurality of servers that configure at least one server unit is coupled to at least one first I/O switch, a plurality of I/O devices that configure at least one first I/O switch and at least one I/O device unit is coupled to at least one second I/O switch, and the server system is provided with a controller that is coupled to the second I/O switch and a management system,
the controller executes a setting in which all servers that are coupled to the first I/O switch can be coupled to all I/O cards that are coupled to the at least one second I/O switch that is coupled to the first I/O switch,
the management system outputs the at least one server unit and the at least one I/O device unit that are included in the server system that has been searched through the second I/O switch,
the management system displays the information that indicates the at least one server unit and the at least one I/O device unit that have been output,
the management system receives the input of a server unit or an I/O device unit that has been specified from the at least one server unit and the at least one I/O device unit that are indicated by the displayed information, and outputs the information of the specified server unit or the specified I/O device unit,
the controller receives the input of the specification of the server unit and the I/O device unit, and
the controller executes a setting in which at least one I/O device that configures the specified I/O device unit is allocated to at least one server that configures the specified server unit to the second I/O switch to which the at least one I/O device is coupled.
